(19) United States
(12) Patent Application Publication
(10) Pub. No.: US 2016/0188977 A1
(43) Pub. Date: Jun. 30, 2016

(54) Mobile Security Robot

(71) Applicant: iRobot Corporation, Bedford, MA (US)

(72) Inventors: Justin H. Kearns, Somerville, MA (US); Orjeta Taka, Bedford, MA (US)

(73) Assignee: iRobot Corporation, Bedford, MA (US)

(21) Appl. No.: 14/944,354

(22) Filed: Nov. 18, 2015

Related U.S. Application Data
(60) Provisional application No. 62/096,747, filed on Dec. 24, 2014.

(51) Int. Cl. G06K 9/00; G06T 7/00; B25J 11/00; G06T 7/60; G06T 7/20; G06F 17/30; H04N 7/18; G06K 9/52

(52) U.S. Cl. CPC G06K 9/00664; H04N 7/18; G06K 9/00288; G06T 7/0079; G06K 9/52; G06T 7/60; G06T 7/2033; G06F 17/30268; G06K 9/00476; B25J 11/002; G06T 2207/30201; G06T 2207/20112; G06T 2207/20024

(57) ABSTRACT

A method of operating a mobile robot includes receiving a layout map corresponding to a patrolling environment at a computing device and maneuvering the robot in the patrolling environment based on the received layout map. The method further includes receiving imaging data of a scene about the robot when the robot maneuvers in the patrolling environment at the computing device. The imaging data is received from one or more imaging sensors disposed on the robot and in communication with the computing device. The method further includes identifying a person in the scene based on the received imaging data and aiming a field of view of at least one imaging sensor to continuously perceive the identified person in the field of view. The method further includes capturing a human recognizable image of the identified person using the at least one imaging sensor.

### CROSS REFERENCE TO RELATED APPLICATION

This U.S. patent application claims priority under 35 U.S.C. §119(e) to U.S. Provisional Application 62/096,747, filed Dec. 24, 2014, which is hereby incorporated by reference in its entirety.

### TECHNICAL FIELD

This disclosure relates to mobile security robots. More specifically, this disclosure relates to mobile security robots using at least one imaging sensor to capture images of ambulating people.

### BACKGROUND

A robot is generally an electro-mechanical machine guided by a computer or electronic programming. Mobile robots have the capability to move around in their environment and are not fixed to one physical location. An example of a mobile robot that is in common use today is an automated guided vehicle or automatic guided vehicle (AGV). An AGV is generally a mobile robot that follows markers or wires in the floor, or uses a vision system or lasers for navigation. Mobile robots can be found in industry, military and security environments.

Some robots use a variety of sensors to obtain data about their surrounding environments, for example, for navigation or obstacle detection and person following. Moreover, some robots use imaging sensors to capture still images or video of objects in their surrounding environments. For example, a robot may patrol an environment and capture images of unauthorized people in its environment using an imaging sensor. The combination of people in motion and dynamics of the robot, however, can pose complications in obtaining acceptable images for recognizing the moving people in the images. For example, a moving person may be outside the center of an image or the combined motion of the robot and the person the robot is photographing may cause the resulting image to be blurred.

### SUMMARY

A security service may use a mobile robot to patrol an environment under surveillance. While patrolling, the robot may use one or more proximity sensors and/or imaging sensors to sense objects in the environment and send reports detailing the sensed objects to one or more remote recipients (e.g., via email over a network). When the robot detects a moving object, the robot may consider a dynamic state of the robot, a dynamic state of the object, and limitations of the imaging sensor to move the robot itself or portion thereof supporting the imaging sensor to aim the imaging sensor relative to the object so as to capture a crisp and clear still image or video of the object. Moreover, the robot may try to determine if the object is a person, for example, by assuming that a moving object is a person, and whether to follow the person to further investigate activities of the person. While aiming the imaging sensor, the robot may try to center the object/person perceived by the imaging sensor in the center of captured images or video. The robot may account for dynamics of the person, such as a location, heading, trajectory and/or velocity of the person, as well as dynamics of the robot, such as holonomic motion and/or lateral velocity, to maneuver the robot and/or aim the at least one imaging sensor to continuously perceive the person within a corresponding field of view of the imaging sensor so that the person is centered in the captured image and the image is clear.

In some implementations, the mobile robot is used in conjunction with a security system. For instance, the security system may communicate with the robot over a network to notify the robot when a disturbance, such as an alarm or unusual activity, is detected in the environment by the security system at a specified location. When notified of the disturbance, the robot may abort a current patrolling routine and maneuver to the specified location to investigate whether or not a trespasser is present. In some examples, the robot communicates with the security system over the network to transmit a surveillance report to the security system (e.g., as an email). The surveillance report may include information regarding a current state of the robot (e.g., location, heading, trajectory, etc.) and/or one or more successive still images or video captured by the imaging sensor. Moreover, the robot may tag each image or video with a location and/or time stamp associated with the capturing of the image or video.

One aspect of the disclosure provides a method of operating a mobile robot. The method includes receiving, at a computing device, a layout map corresponding to a patrolling environment and maneuvering the robot in the patrolling environment based on the received layout map. The method also includes receiving, at the computing device, imaging data of a scene about the robot when the robot maneuvers in the patrolling environment. The imaging data is received from at least one imaging sensor disposed on the robot and is in communication with the computing device. The method further includes identifying, by the computing device, a person in the scene based on the received imaging data, aiming, by the computing device, a field of view of the at least one imaging sensor to continuously perceive the identified person in the field of view based on robot dynamics, person dynamics, and dynamics of the at least one imaging sensor, and capturing, by the computing device, a human recognizable image of the identified person using the at least one imaging sensor.

Implementations of the disclosure may include one or more of the following optional features. In some implementations, the method includes segmenting, by the computing device, the received imaging data into objects and filtering, by the computing device, the objects to remove objects greater than a first threshold size and smaller than a second threshold size. The method further includes identifying, by the computing device, the person in the scene corresponding to at least a portion of the filtered objects. Additionally or alternatively, the first threshold size includes a first height of about 8 feet and the second threshold size includes a second height of about 3 feet.

In some examples, the method includes at least one of at least panning or tilting, by the computing device, the at least one imaging sensor to maintain the corresponding aimed field of view on a facial region of the identified person, or commanding, by the computing device, holonomic motion of the robot to maintain the aimed field of view of the at least one imaging sensor on the facial region of the identified person. The method may include using, by the computing device, a Kalman filter to track and propagate a movement trajectory of the identified person. Additionally or alternatively, the method includes commanding, by the computing device, the robot to move in a planar direction with three planar degrees of freedom while maintaining the aimed field of view of the at least one imaging sensor on the identified person associated with the movement trajectory. The robot may move in the planar direction at a velocity proportional to the movement trajectory of the identified person.

The method may further include commanding, by the computing device, at least one of panning or tilting the at least one imaging sensor to maintain the aimed field of view of the at least one imaging sensor on the identified person associated with the movement trajectory. Additionally or alternatively, at least one of the commanded panning or tilting is at a velocity proportional to the movement trajectory of the identified person. The velocity of the at least one of panning or tilting may be further proportional to a planar velocity of the robot.

In some examples, the method includes reviewing, by the computing device, the captured image to determine whether or not the identified person is perceived in the center of the image or the image is clear. When the identified person is perceived in the center of the image and the image is clear, the method includes storing the captured image in non-transitory memory in communication with the computing device and transmitting, by the computing device, the captured image to a security system in communication with the computing device. When the identified person is perceived outside the center of the image or the image is blurred, the method includes re-aiming the field of view of the at least one imaging sensor to continuously perceive the identified person in the field of view and capturing a subsequent human recognizable image of the identified person using the at least one imaging sensor.

In some implementations, the method includes applying, by the computing device, a location tag to the captured image associated with a location of the identified person and applying, by the computing device, a time tag associated with a time the image was captured. The location tag may define a location on the layout map. The location tag may define a location based on at least one of robot odometry, waypoint navigation, dead-reckoning, or a global positioning system. At least one imaging sensor may include at least one of a still-image camera, a video camera, a stereo camera, or a three-dimensional point cloud imaging sensor.

The robot dynamics may include an acceleration/deceleration limit of a drive system of the robot. For example, the robot dynamics may include an acceleration/deceleration limit associated with a drive command and a deceleration limit associated with a stop command. In some examples, the person dynamics includes a movement trajectory of the person. Moreover, the dynamics of the at least one imaging sensor may include a latency between sending an image capture request to the at least one imaging sensor and the at least one imaging sensor capturing an image. In some examples, the dynamics of the at least one imaging sensor includes a threshold rotational velocity of the imaging sensor relative to an imaging target to capture a clear image of the imaging target.

Another aspect of the disclosure provides a robot. This aspect may include one or more of the following optional features. The robot includes a robot body, a drive system, at least one imaging sensor disposed on the robot body and a controller in communication with the drive system and the at least one imaging sensor. The drive system has a forward driving direction, supports the robot body and is configured to maneuver the robot over a floor surface of a patrolling environment. The controller receives a layout map corresponding to a patrolled environment, issues drive commands to the drive system to maneuver the robot in the patrolling environment based on the received layout map and receives imaging data from the at least one imaging sensor of a scene about the robot when the robot maneuvers in the patrolling environment. The controller further identifies a moving target in the scene based on the received imaging data, aims a field of view of the at least one imaging sensor to continuously perceive the identified target in the field of view and captures a human recognizable image of the identified target using the at least one imaging sensor. The controller may further segment the received imaging data into objects, filter the objects to remove objects greater than a first threshold size and smaller than a second threshold size and identify a person in the scene as the identified target corresponding to at least a portion of the filtered objects. Additionally or alternatively, the first threshold size may include a first height of about 8 feet and the second threshold size may include a second height of about 3 feet.

In some examples, the robot further includes a rotator and a tilter disposed on the robot body in communication with the controller, the rotator and tilter providing at least one of panning and tilting of the at least one imaging sensor. The controller may command the rotator or tilter to at least one of pan or tilt the at least one imaging sensor to maintain the corresponding aimed field of view on a facial region of the identified person or issue drive commands to the drive system to holonomically move the robot to maintain the aimed field of view of the at least one imaging sensor on the facial region of the identified person. The controller may propagate a movement trajectory of the identified person based on the received imaging data. Additionally or alternatively, the controller may command the drive system to drive in a planar direction with three planar degrees of freedom while maintaining the aimed field of view of the at least one imaging sensor on the identified person associated with the movement trajectory. The drive system may drive in the planar direction at a velocity proportional to the movement trajectory of the identified target.

In some examples, the robot further includes a rotator and a tilter disposed on the robot body and in communication with the controller. The rotator and tilter provides at least one of panning and tilting of the at least one imaging sensor, wherein the controller commands the rotator or the tilter to at least one of pan or tilt the at least one imaging sensor to maintain the aimed field of view of the at least one imaging sensor on the identified target associated with the movement trajectory. Additionally or alternatively, the at least one of the commanded panning or tilting is at a velocity proportional to the movement trajectory of the identified target. The velocity of the at least one of panning or tilting may be further proportional to a planar velocity of the robot.

In some examples, the controller reviews the captured image to determine whether the identified target is perceived in the center of the image or the image is clear. When the identified target is perceived in the center of the image and the image is clear, the controller stores the captured image in non-transitory memory in communication with the computing device and transmits the captured image to a security system in communication with the controller. When the identified target is perceived outside the center of the image or the image is blurred, the controller re-aims the field of view of the at least one imaging sensor to continuously perceive the identified target in the field of view and captures a subsequent human recognizable image of the identified target using the at least one imaging sensor. In some implementations, the controller applies a location tag to the captured image associated with a location of the identified target and applies a time tag associated with a time the image was captured. Additionally or alternatively, the location tag defines a location on the layout map. The location tag may further define a location based on at least one of robot odometry, waypoint navigation, dead-reckoning, or a global positioning system. The at least one imaging sensor may include at least one of a still-image camera, a video camera, a stereo camera, or a three-dimensional point cloud imaging sensor.

In some implementations, the controller aims the at least one imaging sensor based on acceleration/deceleration limits of the drive system and a latency between sending an image capture request to the at least one imaging sensor and the at least one imaging sensor capturing an image. The acceleration/deceleration limits of the drive system may include an acceleration/deceleration limit associated with a drive command and a deceleration limit associated with a stop command. The controller may determine a movement trajectory of the identified target and aims the at least one imaging sensor based on the movement trajectory of the identified target. Moreover, the controller may aim the at least one imaging sensor based on a threshold rotational velocity of the at least one imaging sensor relative to identified target to capture a clear image of the identified target.

Yet another aspect of the disclosure provides a second method of operating a mobile robot. This aspect may include one or more of the following optional features. The method includes receiving, at a computing device, a layout map corresponding to a patrolling environment and maneuvering the robot in the patrolling environment based on the received layout map. In response to an alarm in the patrolling environment, the method further includes receiving, at the computing device, a target location from a security system in communication with the computing device. The target location corresponds to a location of the alarm. The method further includes maneuvering the robot in the patrolling environment to the target location, receiving, at the computing device, imaging data of a scene about the robot when the robot maneuvers to the target location and identifying, by the computing device, a moving target in the scene based on the received imaging data. The imaging data received from at least one imaging sensor is disposed on the robot and is in communication with the computing device.

In some implementations, the method includes aiming, by the computing device, a field of view of the at least one imaging sensor to continuously perceive the identified target in the field of view and capturing, by the computing device, a human recognizable image of the identified target using the at least one imaging sensor. The method may also include capturing a human recognizable video stream of the identified target using the at least one imaging sensor. The method may further include at least one of panning or tilting, by the computing device, the at least one imaging sensor to maintain the corresponding aimed field of view on a facial region of the identified target or commanding, by the computing device, holonomic motion of the robot to maintain the aimed field of view of the at least one imaging sensor on the facial region of the identified target.

In some examples, the method includes using, by the computing device, a Kalman filter to track and propagate a movement trajectory of the identified target and issuing, by the computing device, a drive command to drive the robot within a following distance of the identified target based at least in part on the movement trajectory of the identified target. The drive command may include a waypoint drive command to drive the robot within a following distance of the identified target.

The target location defines one of a location on the layout map or a location based on at least one of robot odometry, waypoint navigation, dead-reckoning, or a global positioning system. The method may further include capturing, by the computing device, human recognizable images about the scene of the robot using the at least one imaging sensor while the robot maneuvers in the patrolling environment.

The method may further include at least one of aiming, by the computing device, a field of view of the at least one imaging sensor in a direction substantially normal to a forward drive direction of the robot or scanning, by the computing device, the field of view of the at least one imaging sensor to increase the corresponding field of view. The human recognizable images may be captured during repeating time cycles and at desired locations in the patrolling environment.

In some implementations, the method includes aiming the at least one imaging sensor to perceive the identified target based on acceleration/deceleration limits of the drive system and a latency between sending an image capture request to the at least one imaging sensor and the at least one imaging sensor capturing an image. The acceleration/deceleration limits of the drive system may include an acceleration/deceleration limit associated with a drive command and a deceleration limit associated with a stop command. The method may include determining a movement trajectory of the identified target and aiming the at least one imaging sensor based on the movement trajectory of the identified target. Moreover, the method may include aiming the at least one imaging sensor based on a threshold rotational velocity of the at least one imaging sensor relative to identified target to capture a clear image of the identified target.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example robot interacting with an observed person and communicating with a security system.

FIG. 1B is a schematic view of an example surveillance report.

FIG. 2A is a perspective view of an exemplary mobile robot.

FIG. 2B is a perspective view of an exemplary robot drive system.

FIG. 2C is a front perspective view of another exemplary robot.

FIG. 2D is a rear perspective view of the robot shown in FIG. 2C.

FIG. 2E is side view of the robot shown in FIG. 2C.

FIG. 2F is a front view of an exemplary robot having a detachable tablet computer.

FIG. 2G is a front perspective view of an exemplary robot having an articulated head and mounted tablet computer.

FIG. 3A is a perspective view of an exemplary robot having a sensor module.

FIG. 3B is a perspective view of an exemplary sensor module.

FIG. 3C is a schematic view of an exemplary sensor module.

FIG. 4 provides a schematic view of exemplary robot control flow to and from a controller.

FIG. 5 is a schematic view of an exemplary control system executed by a controller of a mobile robot.

FIG. 6A is a top view of an exemplary mobile robot having a torso rotating with respect to its base.

FIG. 6B is a top view of an exemplary mobile robot having a long range imaging sensor.

FIG. 7A is a schematic view of an exemplary occupancy map.

FIG. 7B is a schematic view of an exemplary mobile robot having a field of view of a scene in a patrolling area.

FIG. 8A is a schematic view of an exemplary mobile robot following a person.

FIG. 8B is a schematic view of an exemplary person detection routine for a mobile robot.

FIG. 8C is a schematic view of an exemplary person tracking routine for a mobile robot.

FIG. 8D is a schematic view of an exemplary person following routine for a mobile robot.

FIG. 8E is a schematic view of an exemplary aiming routine for aiming a field of view of at least one imaging sensor of a mobile robot.

FIG. 9A is a schematic view of an exemplary mobile robot following a person around obstacles.

FIG. 9B is a schematic view of an exemplary local map of a mobile robot being updated with a person location.

FIG. 10A is a schematic view of an exemplary patrolling environment for a mobile robot in communication with a security system.

FIG. 10B is a schematic view of an exemplary layout map corresponding to an example patrolling environment of a mobile robot.

FIG. 11 provides an exemplary arrangement of operations for operating an exemplary mobile robot to navigate about a patrolling environment using a layout map.

FIG. 12A provides an exemplary arrangement of operations for operating an exemplary mobile robot to navigate about a patrolling environment using a layout map and obtain human recognizable images in a scene of the patrolling environment.

FIG. 12B is a schematic view of an exemplary layout map corresponding to an example patrolling environment of a mobile robot.

FIG. 13A provides an exemplary arrangement of operations for operating an exemplary mobile robot when an alarm is triggered while the mobile robot navigates about a patrolling environment using a layout map.

FIG. 13B is a schematic view of an exemplary layout map corresponding to a patrolling environment of a mobile robot.

FIG. 14A is a schematic view of an exemplary mobile robot having a field of view associated with an imaging sensor aimed to perceive a person within the field of view.

FIG. 14B is a schematic view of an exemplary mobile holonomically moving to maintain an aimed field of view of an imaging sensor perceived on a moving person.

FIG. 14C is a schematic view of an exemplary mobile robot turning its neck and head to maintain an aimed field of view of an imaging sensor to perceive a moving person.

FIG. 14D is a schematic view of an exemplary mobile robot driving away from a person after capturing a human recognizable image of the person.

FIG. 15 provides an exemplary arrangement of operations for capturing one or more images of a person identified in a scene of a patrolling environment of an exemplary mobile robot.

Like reference symbols in the various drawings indicate like elements.

### DETAILED DESCRIPTION

Mobile robots can maneuver within environments to provide security services that range from patrolling to tracking and following trespassers. In the example of patrolling, a mobile robot can make rounds within a facility to monitor activity and serve as a deterrence to potential trespassers. For tracking and following, the mobile robot can detect a presence of a person, track movement and predict trajectories of the person, follow the person as he/she moves, capture images of the person and relay the captured images and other pertinent information (e.g., map location, trajectory, time stamp, text message, email communication, aural wireless communication, etc.) to a remote recipient.

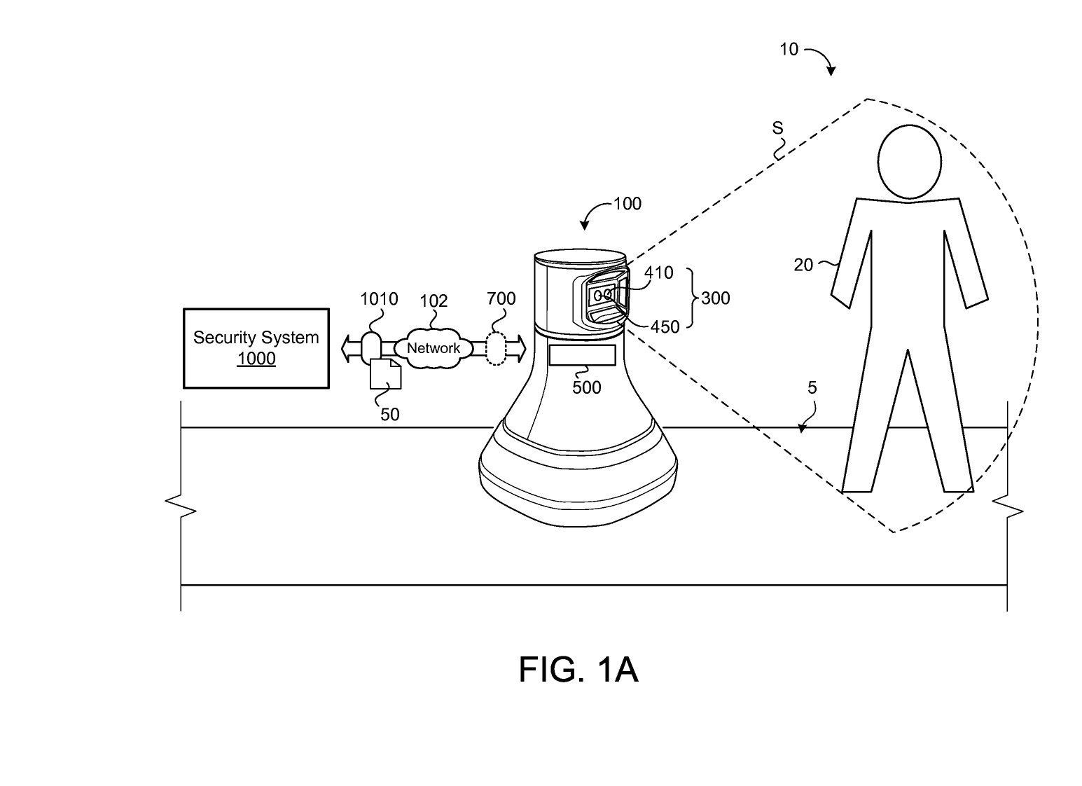

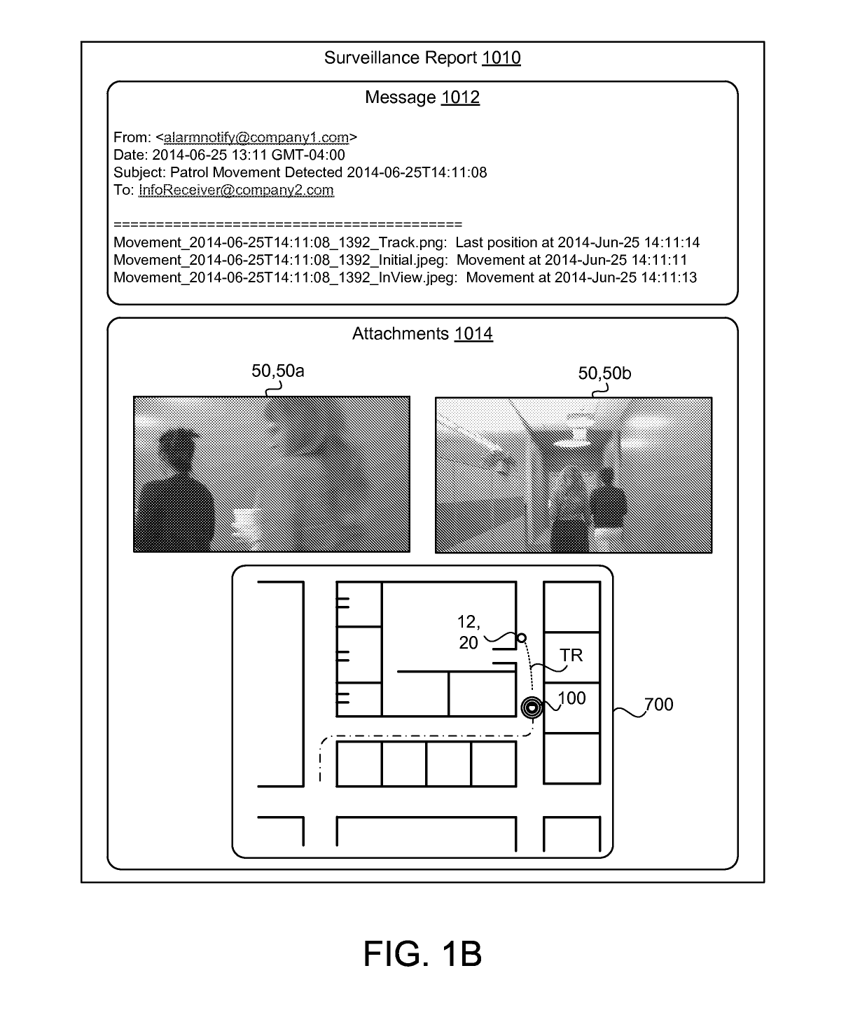

Referring to FIG. 1A, a robot 100 patrolling an environment 10 may sense the presence of a person 20 within that environment 10 using one or more sensors, such as a proximity sensor 410 and/or an imagining sensor 450 of a sensor module 300 in communication with a controller system 500 (also referred to as a controller) of the robot 100. The robot 100 may maneuver to have the person 20 within a sensed volume of space S and/or to capture images 50 (e.g., still images or video) of the person 20 using the imaging sensor 450. The controller 500 may tag the image 50 with a location and/or a time associated with capturing the image 50 of the person 20 and transmit the tagged image 50 in a surveillance report 1010 to a security system 1000. For example, the robot 100 may send the surveillance report 1010 as an email, a text message, a short message service (SMS) message, or an automated voice mail over a network 102 to the remote security system 1000. Other types of messages are possible as well, which may or may not be sent using the network 102.

Referring to FIG. 1B, in some implementations, the surveillance report 1010 includes a message portion 1012 and an attachments portion 1014. The message portion 1012 may indicate an origination of the surveillance report 1010 (e.g., from a particular robot 100), an addressee (e.g., an intended recipient of the surveillance report 1010), a date-time stamp, and/or other information. The attachments portion 1014 may include one or more images 50, 50a-b and/or a layout map 700 showing the current location of the robot 100 and optionally a detected object 12 or person 20. In some embodiments, the imaging sensor 450 is a camera with a fast shutter speed that rapidly takes successive images 50 of one or more moving targets and batches the one or more images 50 for transmission.

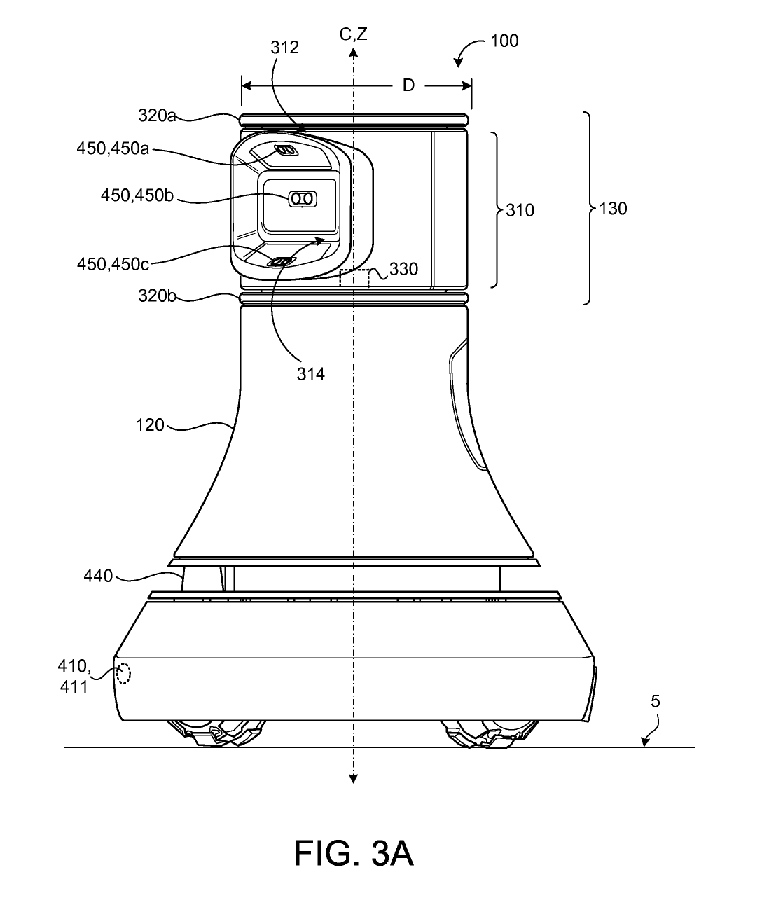

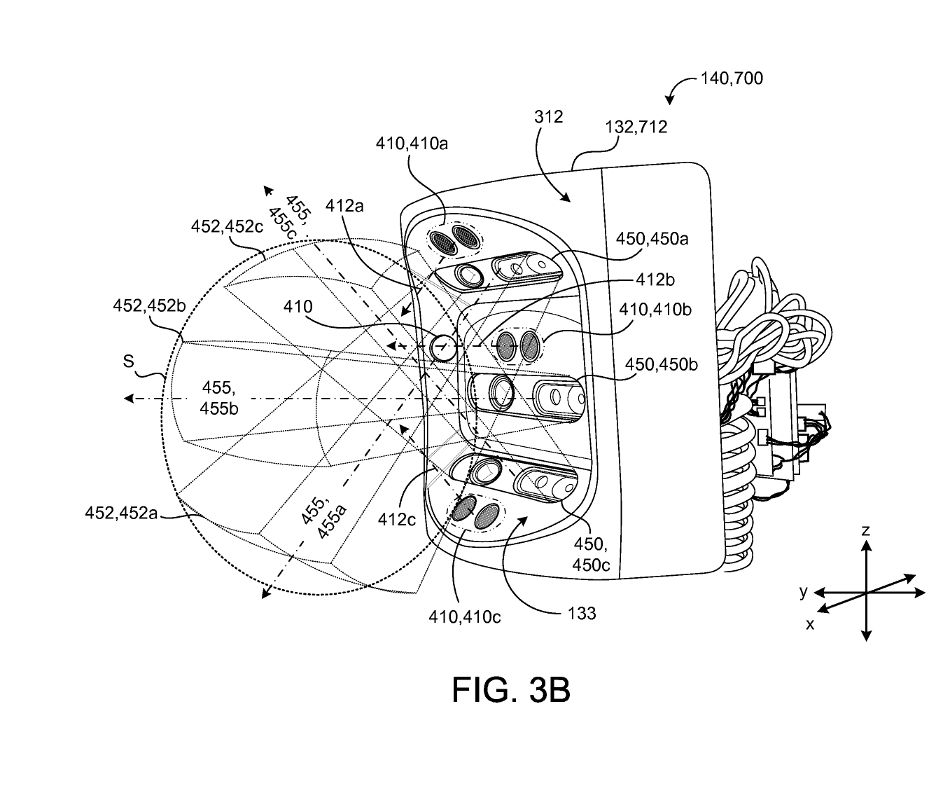

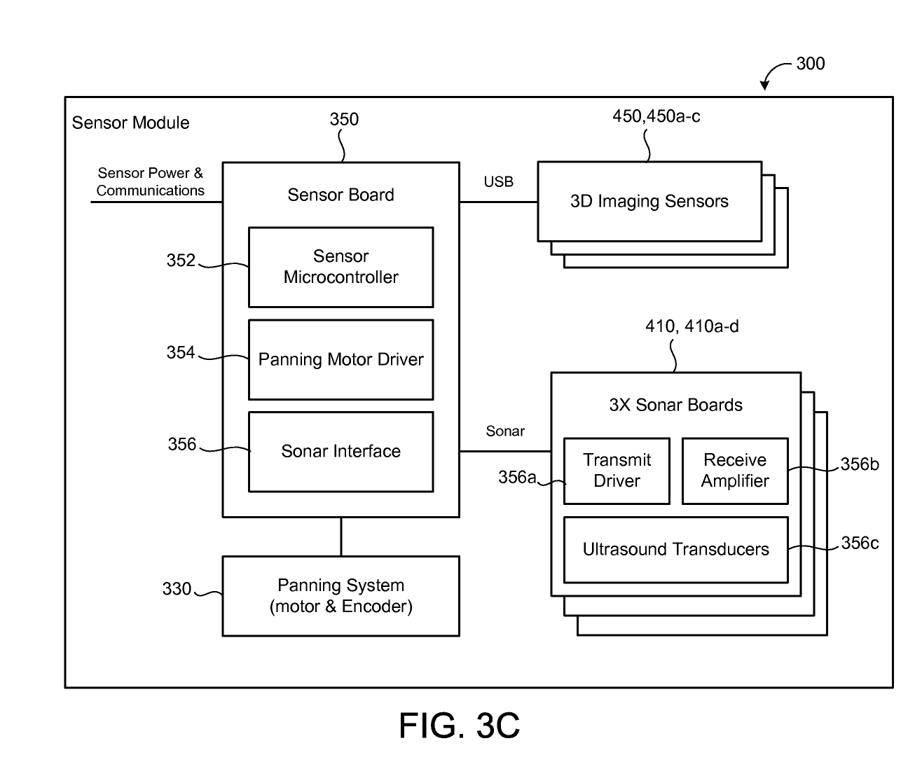

While conventional surveillance cameras can be placed along walls or ceilings within the environment 10 to capture images within the environment 10, it is often very difficult, and sometimes impossible, to recognize trespassers in the image data due to limitations inherent to these conventional surveillance cameras. For instance, due to the placement and stationary nature of wall and/or ceiling mounted surveillance cameras, people 20 are rarely centered within the captured images and the images are often blurred when the people 20 are moving through the environment 10. Additionally, an environment 10 may often include blind spots where surveillance cameras cannot capture images 50. The robot 100 shown in FIGS. 1A and 1B may resolve the aforementioned limitations found in conventional surveillance cameras by maneuvering the robot 100 to capture image data 50 (e.g., still images or video) of the person 20 along a field of view 452 (FIG. 3B) of the imaging sensor 450 while patrolling the environment 10. The controller 500 may account for dynamics of the person 20 (e.g., location, heading, trajectory, velocity, etc.), shutter speed of the imaging sensor 450 and dynamics of the robot 100 (e.g., velocity/holonomic motion) to aim the corresponding field of view 452 of the imaging sensor 450 to continuously perceive the person 20 within the field of view 452, so that the person 20 is centered in the captured image 50 and the image 50 is clear. The controller system 500 may execute movement commands to maneuver the robot 100 in relation to the location of the person 20 to capture a crisp image 50 of a facial region of the person 20, so that the person 20 is recognizable in the image 50. Surveillance reports 1010 received by the security system 1000 that include images 50 depicting the facial region of the person 20 may be helpful for identifying the person 20. The movement commands may be based on a trajectory prediction TR and velocity of the person 20, in addition to dynamics of the robot 100 and/or shutter speed of the imaging sensor 450. The controller 500 integrates the movements of the robot 100, the person 20, and the shutter speed and/or focal limitations of the imaging sensor 450 so that the robot 100 accelerates and decelerates to accommodate for the velocity of the person 20 and the shutter speed and/or focal limitations of the imaging sensor 450 while positioning itself to capture an image 50 (e.g., take a picture) of the moving person 20. The controller 500 predicts the trajectory of the moving person and calculates the stop time and/or deceleration time of the robot 100 and the focal range and shutter speed of the imaging sensor 450 in deciding at which distance from the moving person 20 to capture a photograph or video clip. For instance, when the person 20 is running away from the robot 100, the controller system 500 may command the robot 100 to speed up ahead of the person 20 so that the person 20 is centered in the field of view 452 of the imaging sensor 450 once the robot 100 slows, stops and/or catches up to the person 20 for capturing a clear image 50. In other situations, the controller 500 may command the robot 100 to back away from the person 20 if the person 20 is determined to be too close to the imaging sensor 450 to capture a crisp image 50. Moreover, the controller 500 may command the robot 100 to follow the person 20, for example, at a distance, to observe the person 20 for a period of time.

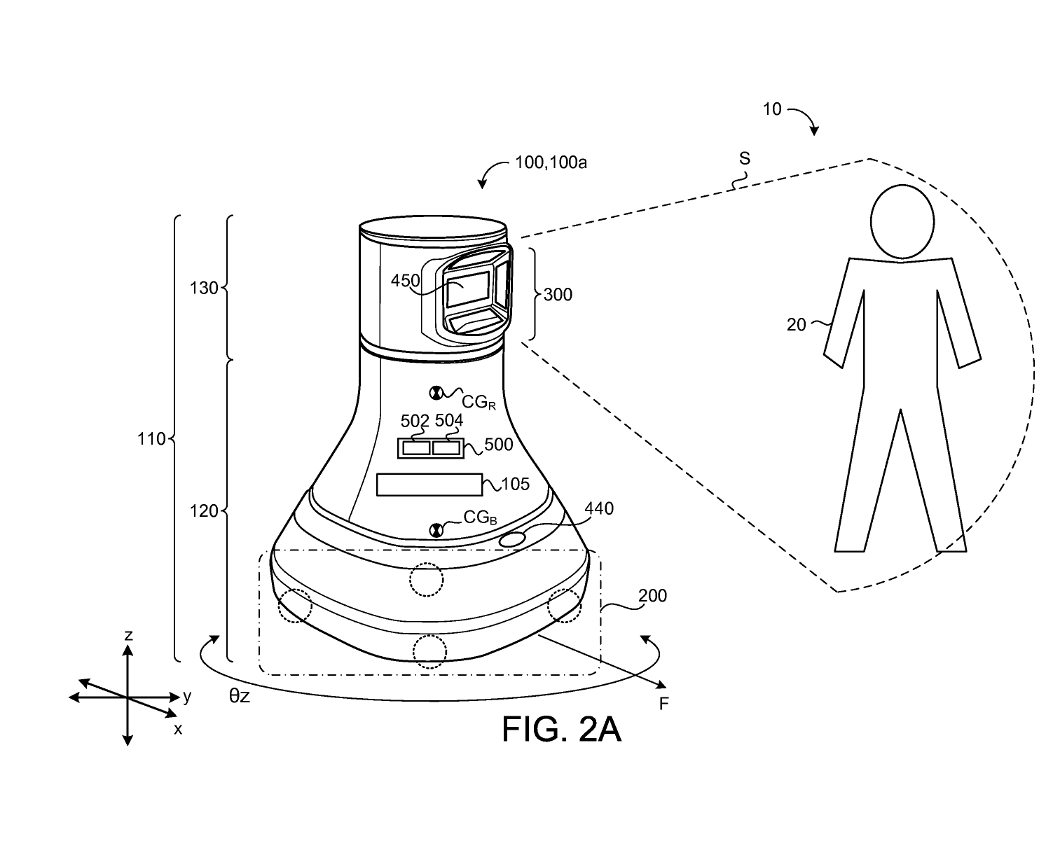

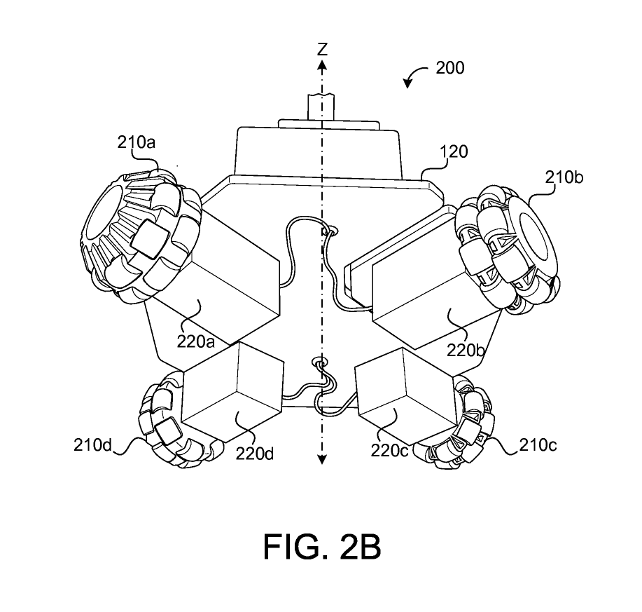

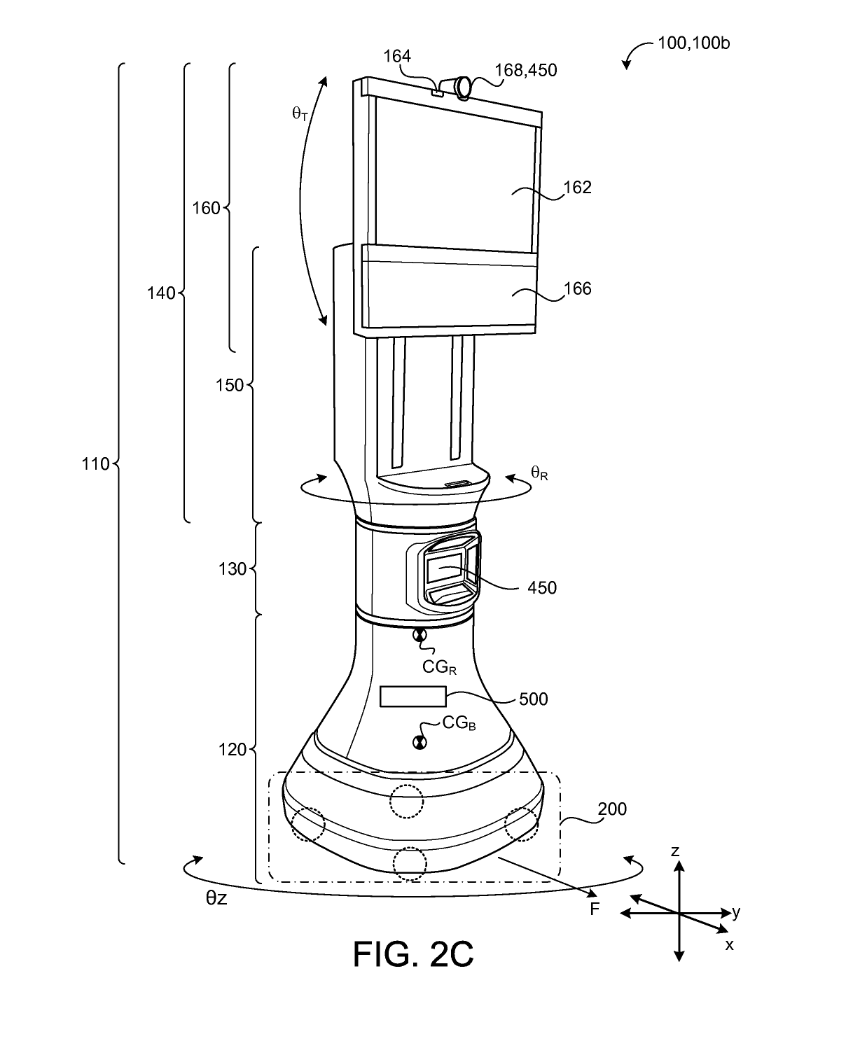

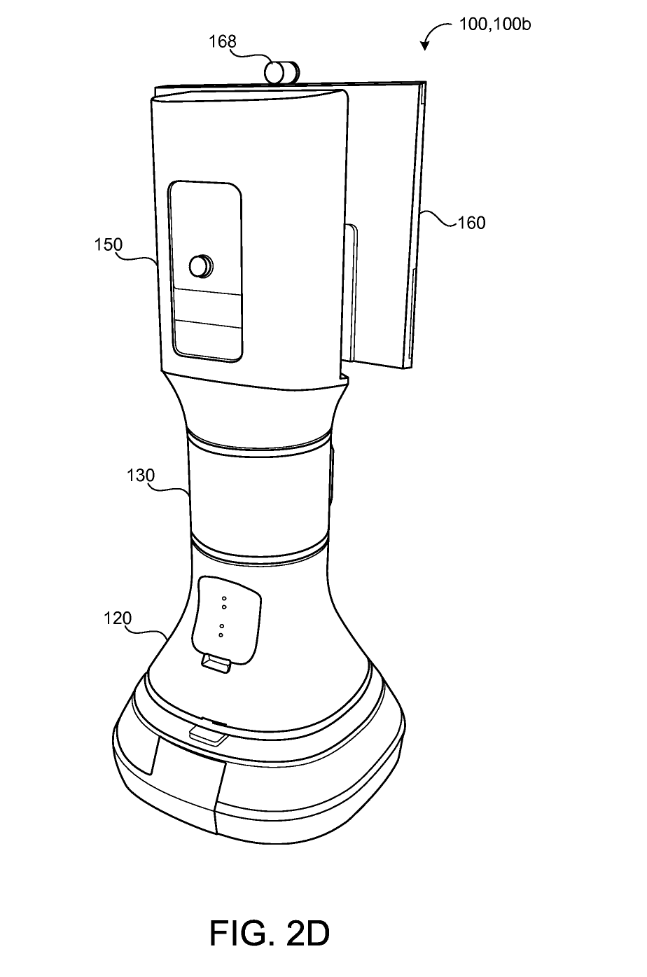

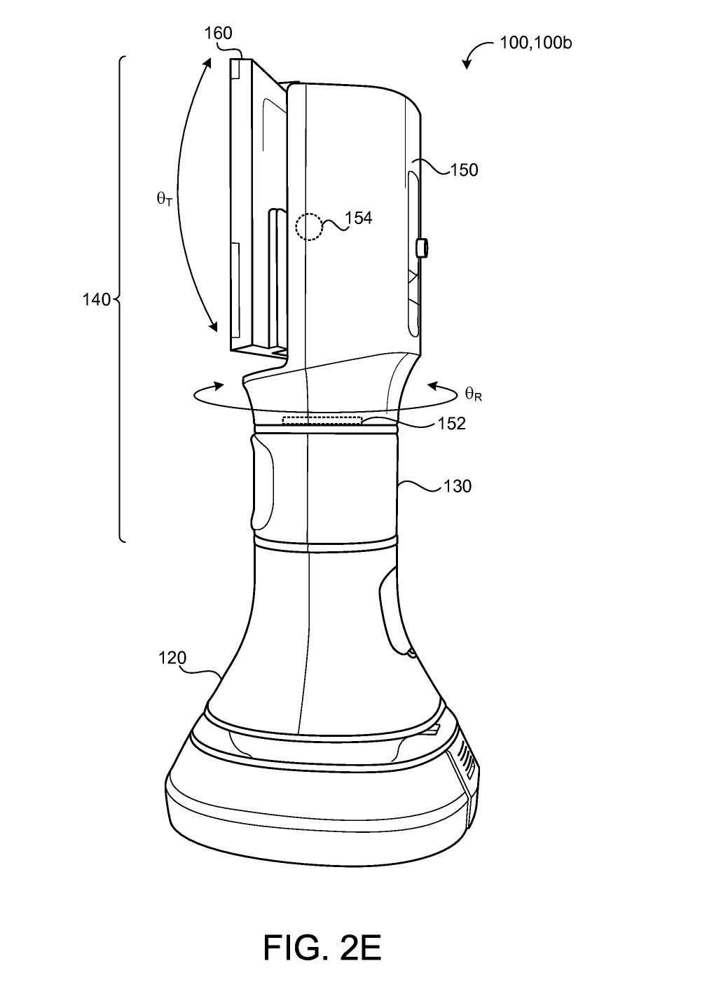

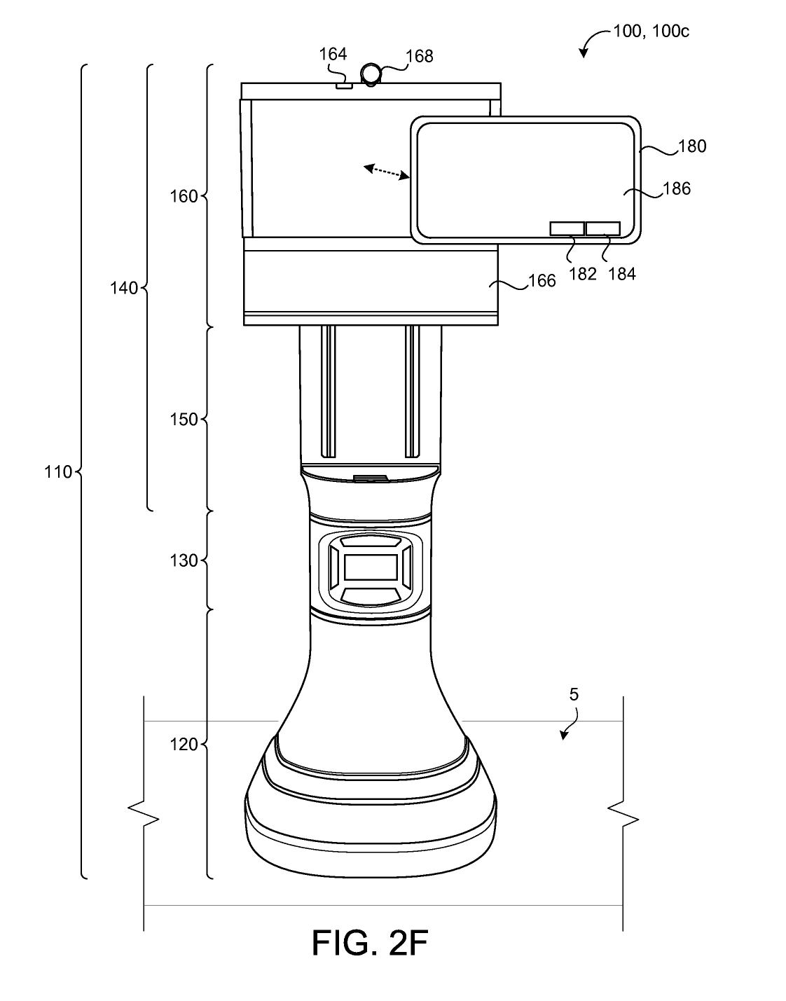

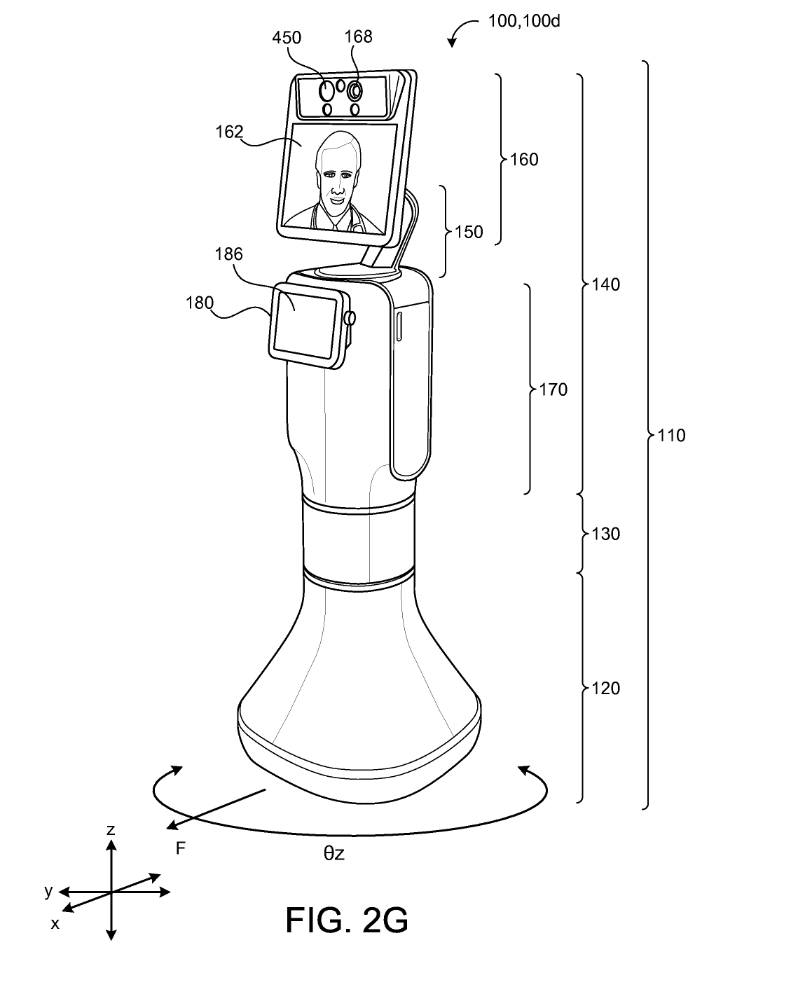

FIGS. 2A-2G illustrate example robots 100, 100a, 100b, 100c, 100d that may patrol an environment 10 for security purposes. Other types of robots 100 are possible as well. In the example shown in FIG. 2A, the robot 100a includes a robot body 110 (or chassis) that defines a forward drive direction F. The robot body 110 may include a base 120 and a torso 130 supported by the base 120. The base 120 may include enough weight (e.g., by supporting a power source 105 (batteries)) to maintain a low center of gravity CG_{B} of the base 120 and a low overall center of gravity CG_{R} of the robot 100 for maintaining mechanical stability. The base 120 may support a drive system 200 configured to maneuver the robot 100 across a floor surface 5. The drive system 200 is in communication with a controller system 500, which can be supported by the base 120 or any other portion of the robot body 110. The controller system 500 may include a computing device 502 (e.g., a computer processor) in communication with non-transitory memory 504.

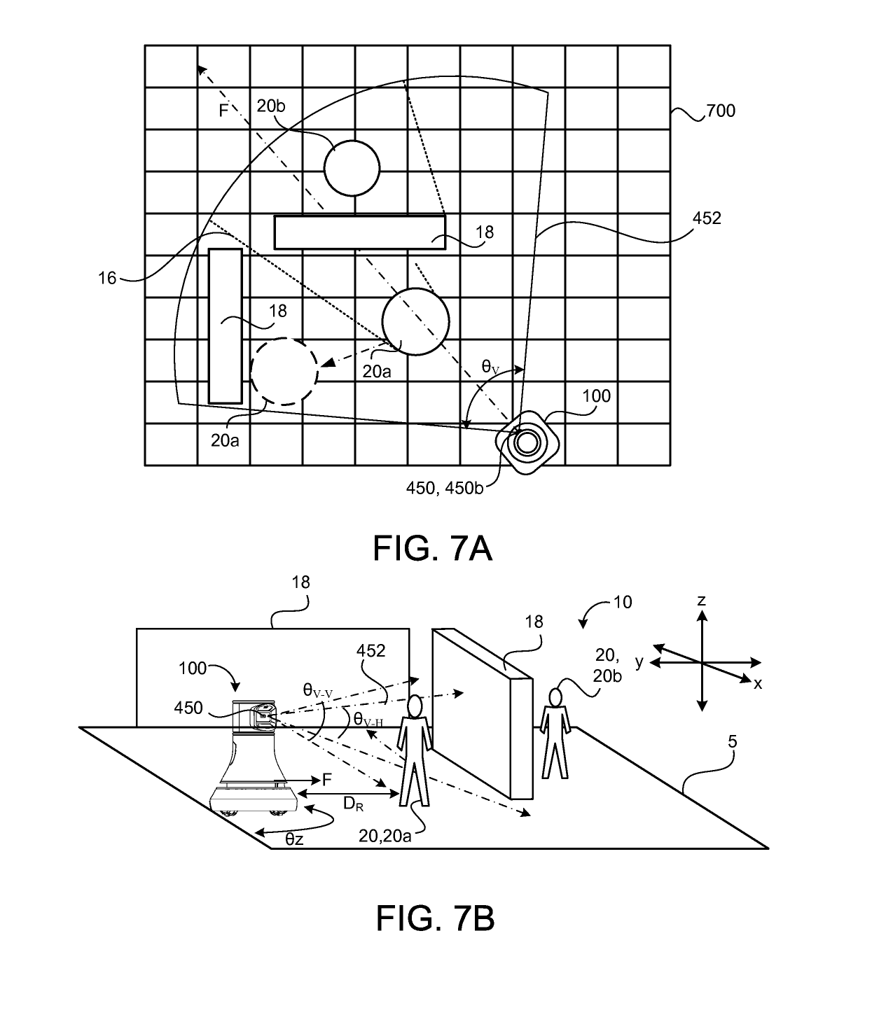

The controller 500 communicates with the security system 1000, which may transmit signals to the controller 500 indicating one or more alarms within the patrolling environment 10 and locations associated with the alarms. The security system 1000 may provide a layout map 700 (FIG. 7B) corresponding to the patrolling environment 10 of the robot 100. Moreover, the controller 500 may transmit one or more human recognizable images 50 captured by at least one imaging sensor 450 to the security system 1000, wherein a person 20 can review the captured images 50. The controller 500 may store the captured images 50 within the non-transitory memory 504. The security system 1000 may further access the non-transitory memory 504 via the controller 500. In the examples shown, the robot 100 houses the controller 500, but in other examples (not shown), the controller 500 can be external to the robot 100 and controlled by a user (e.g., via a handheld computing device).

Referring to FIG. 2B, in some implementations, the drive system 200 provides omni-directional and/or holonomic motion control of the robot 100. As used herein the term “omni-directional” refers to the ability to move in substantially any planar direction, including side-to-side (lateral), forward/back, and rotational. These directions are generally referred to herein as x, y, and θz, respectively. Furthermore, the term “holonomic” is used in a manner substantially consistent with the literature use of the term and refers to the ability to move in a planar direction with three planar degrees of freedom—two translations and one rotation. Hence, a holonomic robot has the ability to move in a planar direction at a velocity made up of substantially any proportion of the three planar velocities (forward/back, lateral, and rotational), as well as the ability to change these proportions in a substantially continuous manner.

The robot 100 can operate in human environments (e.g., environments typically designed for bipedal, walking occupants) using wheeled mobility. In some implementations, the drive system 200 includes first, second, third, and fourth drive wheels 210a, 210b, 210c, 210d, which may be equally spaced (e.g., symmetrically spaced) about the vertical axis Z; however, other arrangements are possible as well, such as having only two or three drive wheels or more than four drive wheels. Each drive wheel 210a-d is coupled to a respective drive motor 220a, 220b, 220c, 220d that can drive the drive wheel 210a-d in forward and/or reverse directions independently of the other drive motors 220a-d. Each drive motor 220a-d can have a respective encoder, which provides wheel rotation feedback to the controller 500 system.

Referring again to FIGS. 2C-2G, in some implementations, the torso 130 supports a payload, such as an interface module 140 and/or a sensor module 300. The interface module 140 may include a neck 150 supported by the torso 130 and a head 160 supported by the neck 150. The neck 150 may provide panning and tilting of the head 160 with respect to the torso 130, as shown in FIG. 2E. In some examples, the neck 150 moves (e.g., telescopically, via articulation, or along a linear track) to alter a height of the head 160 with respect to the floor surface 5. The neck 150 may include a rotator 152 and a tilter 154. The rotator 152 may provide a range of angular movement θ_{R} (e.g., about a Z axis) of between about 90 degrees and about 360 degrees. Other ranges are possible as well. Moreover, in some examples, the rotator 152 includes electrical connectors or contacts that allow continuous 360 degree rotation of the neck 150 and the head 160 with respect to the torso 130 in an unlimited number of rotations while maintaining electrical communication between the neck 150 and the head 160 and the remainder of the robot 100. The tilter 154 may include the same or similar electrical connectors or contacts allowing rotation of the head 160 with respect to the torso 130 while maintaining electrical communication between the head 160 and the remainder of the robot 100. The tilter 154 may move the head 160 independently of the rotator 152 about a Y axis between an angle θ_{T} of ±90 degrees with respect to the Z-axis. Other ranges are possible as well, such as ±45 degrees, etc. The head 160 may include a screen 162 (e.g., touch screen), a microphone 164, a speaker 166, and an imaging sensor 168, as shown in FIG. 2C. The imaging sensor 168 can be used to capture still images, video, and/or 3D volumetric point clouds from an elevated vantage point of the head 160.

In some implementations, the head 160 is or includes a fixedly or releasably attached tablet computer 180 (referred to as a tablet), as shown in FIG. 2F. The tablet computer 180 may include a processor 182, non-transitory memory 184 in communication with the non-transitory memory 184, and a screen 186 (e.g., touch screen) in communication with the processor 182, and optionally I/O (e.g., buttons and/or connectors, such as micro-USB, etc.). An example tablet 180 includes the Apple iPad® by Apple, Inc. In some examples, the tablet 180 functions as the controller system 500 or assists the controller system 500 in controlling the robot 100.

The tablet 180 may be oriented forward, rearward or upward. In the example shown in FIG. 2G, the robot 100, 100c includes a tablet 180 attached to a payload portion 170 of the interface module 140. The payload portion 170 may be supported by the torso 130 and supports the neck 150 and head 160, for example, in an elevated position, so that the head 160 is between about 4 ft. and 6 ft. above the floor surface 5 (e.g., to allow a person 20 to view the head 160 while looking straight forward at the robot 100).

Referring to FIGS. 3A and 3B, in some implementations, the torso 130 includes a sensor module 300 having a module body 310. The module body 310 (also referred to as a cowling or collar) may have a surface of revolution that sweeps about a vertical axis of rotation C of the module body 310 (also referred to as a collar axis) with respect to the floor surface 5. A surface of revolution is a surface in Euclidean space created by rotating a curve (the generatrix) around a straight line (e.g., the Z axis) in its plane. In some examples, the module body 310 defines a three dimensional projective surface of any shape or geometry, such as a polyhedron, circular or an elliptical shape. The module body 310 may define a curved forward face 312 (e.g., of a cylindrically shaped body axially aligned with the base 120) defining a recess or cavity 314 that houses imaging sensor(s) 450 of the sensor module 300, while maintaining corresponding field(s) of view 452 of the imaging sensor(s) 450 unobstructed by the module body 310. Placement of an imaging sensor 450 on or near the forward face 312 of the module body 310 allows the corresponding field of view 452 (e.g., about 285 degrees) to be less than an external surface angle of the module body 310 (e.g., 300 degrees) with respect to the imaging sensor 450, thus preventing the module body 310 from occluding or obstructing the detection field of view 452 of the imaging sensor 450. Placement of the imaging sensor(s) 450 inside the cavity 314 conceals the imaging sensor(s) 450 (e.g., for aesthetics, versus having outwardly protruding sensors) and reduces a likelihood of environmental objects snagging on the imaging sensor(s) 450. Unlike a protruding sensor or feature, the recessed placement of the image sensor(s) 450 reduces unintended interactions with the environment 10 (e.g., snagging on people 20, obstacles, etc.), especially when moving or scanning, as virtually no moving part extends beyond the envelope of the module body 310.

In some examples, the sensor module 300 includes a first interface 320a and a second interface 320b spaced from the first interface 320a. The first and second interfaces 320a, 320b rotatably support the module body 310 therebetween. A module actuator 330, also referred to as a panning system (e.g., having a panning motor and encoder), may rotate the module body 310 and the imaging sensor(s) 450 together about the collar axis C. All rotating portions of the imaging sensor(s) 450 extend a lesser distance from the collar axis C than an outermost point of the module body 310.

The sensor module 300 may include one or more imaging sensors 450 of a sensor system 400. The imaging sensor(s) 450 may be a three-dimensional depth sensing device that directly captures three-dimensional volumetric point clouds (e.g., not by spinning like a scanning LIDAR) and can point or aim at an object that needs more attention. The imaging sensor(s) 450 may reciprocate or scan back and forth slowly as well. The imaging sensor(s) 450 may capture point clouds that are 58 degrees wide and 45 degrees vertical, at up to 60 Hz.

In some implementations, the sensor module 300 includes first, second, and third imaging sensors 450, 450a, 450b, 450c. Each imaging sensor 450 is arranged to have a field of view 452 centered about an imaging axis 455 directed along the forward drive direction F. In some implementations, one or more imaging sensors 450 are long range sensors having a field of view 452 centered about an imaging axis 455 directed along the forward drive direction F. The first imaging sensor 450a is arranged to aim its imaging axis 455a downward and away from the torso 130. By angling the first imaging sensor 450a downward, the robot 100 receives dense sensor coverage in an area immediately forward or adjacent to the robot 100, which is relevant for short-term travel of the robot 100 in the forward direction. The second imaging sensor 450b is arranged with its imaging axis 455b pointing substantially parallel with the ground along the forward drive direction F (e.g., to detect objects approaching a mid and/or upper portion of the robot 100). The third imaging sensor 450c is arranged to have its imaging axis 455c aimed upward and away from the torso 130.

The robot 100 may rely on one or more imaging sensors 450a-c more than the remaining imaging sensors 450a-c during different rates of movement, such as fast, medium, or slow travel. Fast travel may include moving at a rate of 3-10 mph or corresponding to a running pace of an observed person 20. Medium travel may include moving at a rate of 1-3 mph, and slow travel may include moving at a rate of less than 1 mph. During fast travel, the robot 100 may use the first imaging sensor 450a, which is aimed downward to increase a total or combined field of view of both the first and second imaging sensors 450a, 450b, and to give sufficient time for the robot 100 to avoid an obstacle because higher speeds of travel lengthens reaction time when avoiding collisions with obstacles. During slow travel, the robot 100 may use the third imaging sensor 450c, which is aimed upward above the ground 5, to track a person 20 that the robot 100 is meant to follow. The third imaging sensor 450c can be arranged to sense objects as they approach a payload 170 of the torso 130. In some examples, the one or both of the second and third imaging sensors 450b, 450c are imaging sensors configured to capture still images and/or video of a person 20 within the field of view 452.

The captured separate three dimensional volumetric point clouds of the imaging sensors 450a-c may be of overlapping or non-overlapping sub-volumes or fields of view 452a-c within an observed volume of space S (FIGS. 2A and 3B). Moreover, the imaging axes 455a-c of the imaging sensors 450a-c may be angled with respect to a plane normal to the collar axis C to observe separate sub-volumes 452 of the observed volume of space S. The separate sub-volumes 452 are fields of view that can be displaced from one another along the collar axis C.

The imaging axis 455 of one of the imaging sensors 450a-c (e.g., the first imaging axis 455a or third imaging axis 455c) may be angled with respect to the plane normal to the collar axis C to observe the volume of space S adjacent the robot 100 at a height along the collar axis C that is greater than or equal to a diameter D of the collar 310.

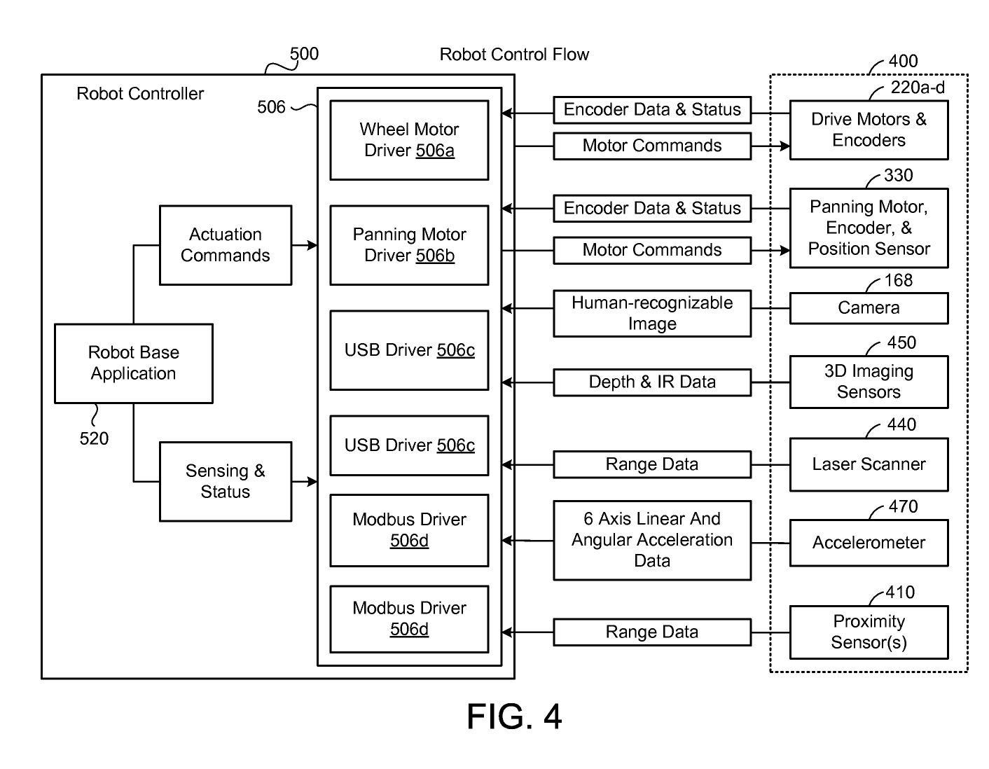

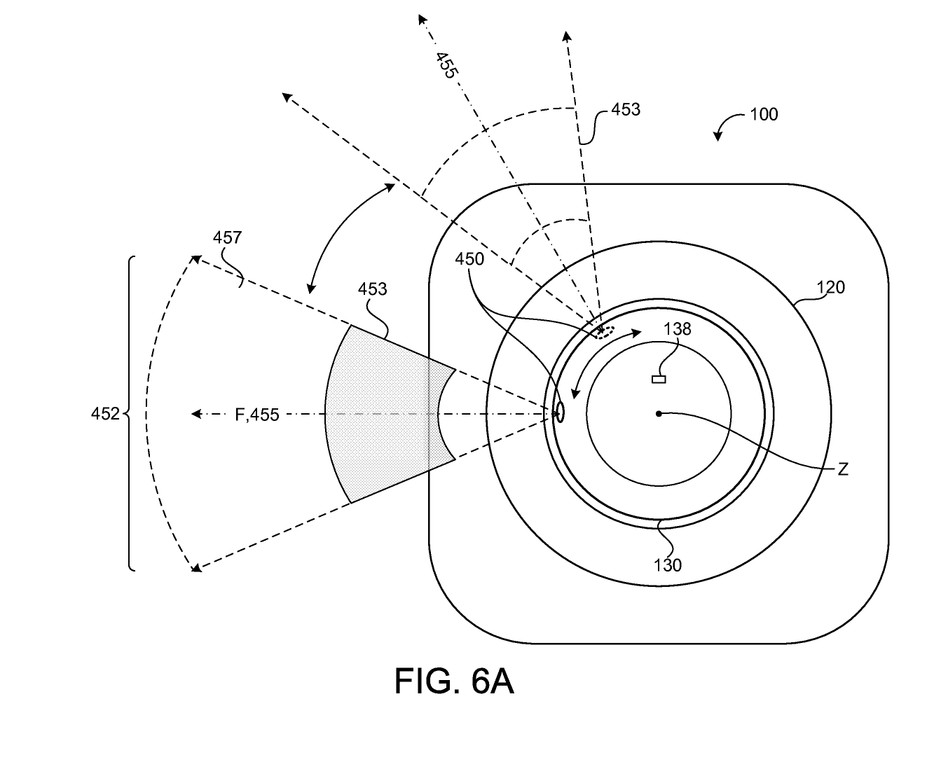

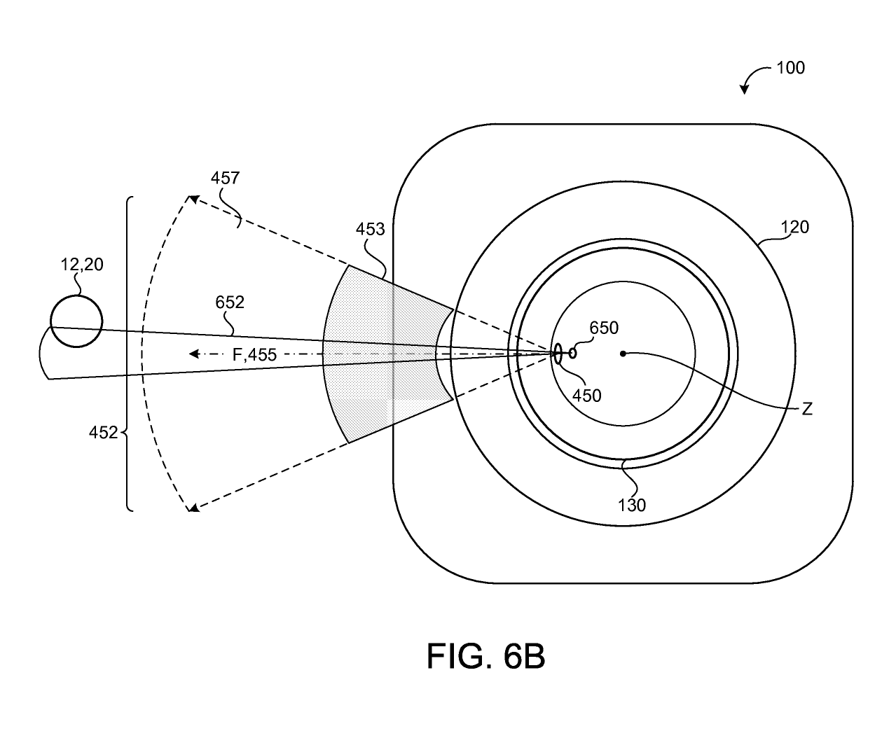

In some implementations, the torso body 132 supports or houses one or more proximity sensors 410 (e.g., infrared sensors, sonar sensors and/or stereo sensors) for detecting objects and/or obstacles about the robot 100. In the example shown in FIG. 4, the torso body 132 includes first, second, and third proximity sensors 410a, 410b, 410c disposed adjacent to the corresponding first, second, and third imaging sensor 450a, 450b, 450c and having corresponding sensing axes 412a, 412b, 412c arranged substantially parallel to the corresponding imaging axes 455a, 455b, 455c of the first, second, and third imaging sensors 450a, 450b, 450c. The sensing axes 412a, 412b, 412c may extend into the torso body 132 (e.g., for recessed or internal sensors). Having the first, second, and third proximity sensors 410a, 410b, 410c arranged to sense along substantially the same directions as the corresponding first, second, and third imaging sensors 450a, 450b, 450c provides redundant sensing and/or alternative sensing for recognizing objects or portions of the local environment 10 and for developing a robust local perception of the robot's environment. Moreover, the proximity sensors 410 may detect objects within an imaging dead zone 453 (FIG. 6A) of imaging sensors 450.

The torso 130 may support an array of proximity sensors 410 disposed within the torso body recess 133 and arranged about a perimeter of the torso body recess 133, for example in a circular, elliptical, or polygonal pattern. Arranging the proximity sensors 410 in a bounded (e.g., closed loop) arrangement, provides proximity sensing in substantially all directions along the drive direction of the robot 100. This allows the robot 100 to detect objects and/or obstacles approaching the robot 100 within at least a 180 degree sensory field of view along the drive direction of the robot 100.

In some examples, one or more torso sensors, including one or more imaging sensors 450 and/or proximity sensors 410, have an associated actuator moving the sensor 410, 450 in a scanning motion (e.g., side-to side) to increase the sensor field of view 452. In additional examples, the imaging sensor 450 includes an associated rotating mirror, prism, variable angle micro-mirror, or MEMS mirror array to increase the field of view 452 of the imaging sensor 450. Mounting the sensors 410, 450 on a round or cylindrically shaped torso body 132 allows the sensors 410, 450 to scan in a relatively wider range of movement, thus increasing the sensor field of view 452 relatively greater than that of a flat faced torso body 132.

Referring to FIG. 3C, in some examples, the sensor module 300 includes a sensor board 350 (e.g., printed circuit board) having a microcontroller 352 (e.g., processor) in communication with a panning motor driver 354 and a sonar interface 356 for the sonar proximity sensors 410a-c. The sensor board 350 communicates with the collar actuator 330 (e.g., panning motor and encoder), the imaging sensor(s) 450, and the proximity sensor(s) 410. Each proximity sensor 410 may include a transmit driver 356a, a receiver amplifier 356b, and an ultrasound transducer 356c.

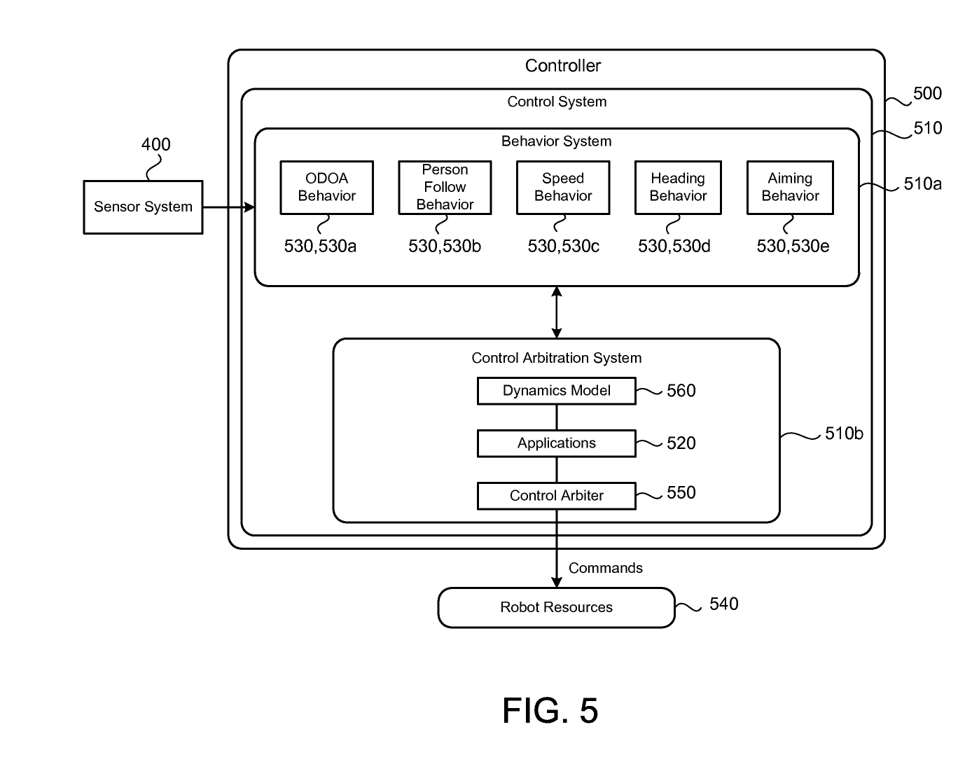

FIG. 4 provides a schematic view of the robot control flow to and from the controller 500. A robot base application 520 executing on the controller 500 (e.g., executing on a control arbitration system 510b (FIG. 5)) communicates with drivers 506 for communicating with the sensor system 400. To achieve reliable and robust autonomous movement, the sensor system 400 may include several different types of sensors, which can be used in conjunction with one another to create a perception of the robot's environment sufficient to allow the robot 100 to make intelligent decisions about actions to take in that environment 10. The sensor system 400 may include one or more types of sensors supported by the robot body 110, which may include obstacle detection obstacle avoidance (ODOA) sensors, communication sensors, navigation sensors, etc. For example, these sensors may include, but are not limited to, drive motors 220a-d, a panning motor 330, a camera 168 (e.g., visible light and/or infrared camera), proximity sensors 410, contact sensors, three-dimensional (3D) imaging/depth map sensors 450, a laser scanner 440 (LIDAR (Light Detection And Ranging, which can entail optical remote sensing that measures properties of scattered light to find range and/or other information of a distant target) or LADAR (Laser Detection and Ranging)), an inertial measurement unit (IMU) 470, radar, etc.

The imaging sensors 450 (e.g., infrared range sensors or volumetric point cloud sensors) may generate range value data representative of obstacles within an observed volume of space adjacent the robot 100. Moreover, the proximity sensors 410 (e.g., presence sensors) may generate presence value data representative of obstacles within the observed volume of space. In some implementations, the imaging sensor 450 is a structured-light 3D scanner that measures the three-dimensional shape of an object using projected light patterns. Projecting a narrow band of light onto a three-dimensionally shaped surface produces a line of illumination that appears distorted from other perspectives than that of the projector, and can be used for an exact geometric reconstruction of the surface shape (light section). The imaging sensor 450 may use laser interference or projection as a method of stripe pattern generation. The laser interference method works with two wide planar laser beam fronts. Their interference results in regular, equidistant line patterns. Different pattern sizes can be obtained by changing the angle between these beams. The method allows for the exact and easy generation of very fine patterns with unlimited depth of field. The projection method uses non coherent light and basically works like a video projector. Patterns are generated by a display within the projector, typically an LCD (liquid crystal) or LCOS (liquid crystal on silicon) display.

In some implementations, the imaging sensor 450 is a still-image camera, a video camera, a stereo camera, or a three-dimensional point cloud imaging sensor configured to capture still images and/or video. The imaging sensor 450 may capture one or more images and/or video of a person 20 identified within the environment 10 of the robot 100. In some examples, the camera is used for detecting objects and detecting object movement when a position of the object changes in an occupancy map in successive images.

In some implementations, the imaging sensor 450 is a time-of-flight camera (TOF camera), which is a range imaging camera system that resolves distance based on the known speed of light, measuring the time-of-flight of a light signal between the camera and the subject for each point of the image. The time-of-flight camera is a class of scannerless LIDAR, in which the entire scene is captured with each laser or light pulse, as opposed to point-by-point with a laser beam, such as in scanning LIDAR systems.

In some implementations, the imaging sensor 450 is a three-dimensional light detection and ranging sensor (e.g., Flash LIDAR). LIDAR uses ultraviolet, visible, or near infrared light to image objects and can be used with a wide range of targets, including non-metallic objects, rocks, rain, chemical compounds, aerosols, clouds and even single molecules. A narrow laser beam can be used to map physical features with very high resolution. Wavelengths in a range from about 10 micrometers to the UV (ca. 250 nm) can be used to suit the target. Typically light is reflected via backscattering. Different types of scattering are used for different LIDAR applications; most common are Rayleigh scattering, Mie scattering and Raman scattering, as well as fluorescence.

In some implementations, the imaging sensor 450 includes one or more triangulation ranging sensors, such as a position sensitive device. A position sensitive device and/or position sensitive detector (PSD) is an optical position sensor (OPS) that can measure a position of a light spot in one or two-dimensions on a sensor surface. PSDs can be divided into two classes, which work according to different principles. In the first class, the sensors have an isotropic sensor surface that has a raster-like structure that supplies continuous position data. The second class has discrete sensors on the sensor surface that supply local discrete data.

The imaging sensor 450 may employ range imaging for producing a 2D image showing the distance to points in a scene from a specific point, normally associated with some type of sensor device. A stereo camera system can be used for determining the depth to points in the scene, for example, from the center point of the line between their focal points.

The imaging sensor 450 may employ sheet of light triangulation. Illuminating the scene with a sheet of light creates a reflected line as seen from the light source. From any point out of the plane of the sheet, the line will typically appear as a curve, the exact shape of which depends both on the distance between the observer and the light source and the distance between the light source and the reflected points. By observing the reflected sheet of light using the imaging sensor 450 (e.g., as a high resolution camera) and knowing the positions and orientations of both camera and light source, the robot 100 can determine the distances between the reflected points and the light source or camera.

In some implementations, the proximity or presence sensor 410 includes at least one of a sonar sensor, ultrasonic ranging sensor, a radar sensor (e.g., including Doppler radar and/or millimeter-wave radar), or pyrometer. A pyrometer is a non-contacting device that intercepts and measures thermal radiation. Moreover, the presence sensor 410 may sense at least one of acoustics, radiofrequency, visible wavelength light, or invisible wavelength light. The presence sensor 410 may include a non-infrared sensor, for example, to detect obstacles having poor infrared response (e.g., angled, curved and/or specularly reflective surfaces). In some examples, the presence sensor 410 detects a presence of an obstacle within a dead band of the imaging or infrared range sensor 450 substantially immediately adjacent that sensor (e.g., within a range at which the imaging sensor 450 is insensitive (e.g., 1 cm-40 cm; or 5 m-infinity)).

The laser scanner 440 scans an area about the robot 100 and the controller 500, using signals received from the laser scanner 440, may create an environment map or object map of the scanned area. The controller 500 may use the object map for navigation, obstacle detection, and obstacle avoidance. Moreover, the controller 500 may use sensory inputs from other sensors of the sensor system 400 for creating an object map and/or for navigation. In some examples, the laser scanner 440 is a scanning LIDAR, which may use a laser that quickly scans an area in one dimension, as a “main” scan line, and a time-of-flight imaging element that uses a phase difference or similar technique to assign a depth to each pixel generated in the line (returning a two dimensional depth line in the plane of scanning) In order to generate a three dimensional map, the LIDAR can perform an “auxiliary” scan in a second direction (for example, by “nodding” the scanner). This mechanical scanning technique can be complemented, if not supplemented, by technologies, such as the “Flash” LIDAR/LADAR and “Swiss Ranger” type focal plane imaging element sensors and techniques, which use semiconductor stacks to permit time of flight calculations for a full 2-D matrix of pixels to provide a depth at each pixel, or even a series of depths at each pixel (with an encoded illuminator or illuminating laser).

In some examples, the robot base application 520 communicates with a wheel motor driver 506a for sending motor commands and receiving encoder data and status from the drive motors 220a-d. The robot base application 520 may communicate with a panning motor driver 506b for sending motor commands and receiving encoder data and status from the panning system 330. The robot base application 520 may communicate with one or more USB drivers 506c for receiving sensor data from the camera 168, a LIDAR sensor 440 (FIG. 1A) and/or the 3D imaging sensor(s) 450. Moreover, the robot base application 520 may communicate with one or more Modbus drivers 506d for receiving six axis linear and angular acceleration data from an internal measurement unit (IMU) 470 and/or range data from the proximity sensors 410.

The sensor system 400 may include an inertial measurement unit (IMU) 470 in communication with the controller 500 to measure and monitor a moment of inertia of the robot 100 with respect to the overall center of gravity CG_{R} of the robot 100. The controller 500 may monitor any deviation in feedback from the IMU 470 from a threshold signal corresponding to normal unencumbered operation. For example, if the robot 100 begins to pitch away from an upright position, it may be “clothes lined” or otherwise impeded, or someone may have suddenly added a heavy payload. In these instances, it may be necessary to take urgent action (including, but not limited to, evasive maneuvers, recalibration, and/or issuing an audio/visual warning) in order to ensure safe operation of the robot 100.

Since the robot 100 may operate in a human environment 10, it may interact with humans 20 and operate in spaces designed for humans 20 (and without regard for robot constraints). The robot 100 can limit its drive speeds and accelerations when in a congested, constrained, or highly dynamic environment, such as at a cocktail party or busy hospital. However, the robot 100 may encounter situations where it is safe to drive relatively fast, as in a long empty corridor, but yet be able to decelerate suddenly, for example when something crosses the robots' motion path.

When accelerating from a stop, the controller 500 may take into account a moment of inertia of the robot 100 from its overall center of gravity CG_{R} to prevent robot tipping. The controller 500 may use a model of its pose, including its current moment of inertia. When payloads are supported, the controller 500 may measure a load impact on the overall center of gravity CG_{R} and monitor movement of the robot moment of inertia. For example, the torso 130 and/or neck 150 may include strain gauges to measure strain. If this is not possible, the controller 500 may apply a test torque command to the drive wheels 210a-d and measure actual linear and angular acceleration of the robot 100 using the IMU 470, in order to experimentally determine safe limits.

Referring to FIG. 5, in some implementations, the controller 500 (e.g., a device having one or more computing processors 502 in communication with non-transitory memory 504 capable of storing instructions executable on the computing processor(s) 502) executes a control system 510, which includes a behavior system 510a and a control arbitration system 510b in communication with each other. The control arbitration system 510b allows robot applications 520 to be dynamically added and removed from the control system 510, and facilitates allowing applications 520 to each control the robot 100 without needing to know about any other applications 520. In other words, the control arbitration system 510b provides a simple prioritized control mechanism between applications 520 and resources 540 of the robot 100. The resources 540 may include the drive system 200, the sensor system 400, and/or any payloads or controllable devices in communication with the controller 500.

The applications 520 can be stored in memory of or communicated to the robot 100, to run concurrently on (e.g., on a processor) and simultaneously control the robot 100. The applications 520 may access behaviors 530 of the behavior system 510a. The independently deployed applications 520 are combined dynamically at runtime and can share robot resources 540 (e.g., drive system 200, base 120, torso 130 (including sensor module 300), and optionally the interface module 140 (including the neck 150 and/or the head 160)) of the robot 100. The robot resources 540 may be a network of functional modules (e.g. actuators, drive systems, and groups thereof) with one or more hardware controllers. A low-level policy is implemented for dynamically sharing the robot resources 540 among the applications 520 at run-time. The policy determines which application 520 has control of the robot resources 540 required by that application 520 (e.g. a priority hierarchy among the applications 520). Applications 520 can start and stop dynamically and run completely independently of each other. The control system 510 also allows for complex behaviors 530, which can be combined together to assist each other.

The control arbitration system 510b includes one or more application(s) 520 in communication with a control arbiter 550. The control arbitration system 510b may include components that provide an interface to the control arbitration system 510b for the applications 520. Such components may abstract and encapsulate away the complexities of authentication, distributed resource control arbiters, command buffering, coordinate the prioritization of the applications 520 and the like. The control arbiter 550 receives commands from every application 520, generates a single command based on the applications' priorities, and publishes it for the resources 540. The control arbiter 550 receives state feedback from the resources 540 and may send the state feedback to the applications 520. The commands of the control arbiter 550 are specific to each resource 540 to carry out specific actions.

A dynamics model 560 executable on the controller 500 is configured to compute the center for gravity (CG) and moments of inertia of various portions of the robot 100 for assessing a current robot state. The dynamics model 560 may be configured to calculate the center of gravity CG_{R} of the robot 100, the center of gravity CG_{B} of the base 120, or the center of gravity of other portions of the robot 100. The dynamics model 560 may also model the shapes, weight, and/or moments of inertia of these components. In some examples, the dynamics model 560 communicates with the IMU 470 or portions of one (e.g., accelerometers and/or gyros) in communication with the controller 500 for calculating the various centers of gravity of the robot 100 and determining how quickly the robot 100 can decelerate and not tip over. The dynamics model 560 can be used by the controller 500, along with other applications 520 or behaviors 530 to determine operating envelopes of the robot 100 and its components.

In some implementations, a behavior 530 is a plug-in component that provides a hierarchical, state-full evaluation function that couples sensory feedback from multiple sources, such as the sensor system 400, with a-priori limits and information into evaluation feedback on the allowable actions of the robot 100. Since the behaviors 530 are pluggable into the application 520 (e.g., residing inside or outside of the application 520), they can be removed and added without having to modify the application 520 or any other part of the control system 510. Each behavior 530 is a standalone policy. To make behaviors 530 more powerful, it is possible to attach the output of multiple behaviors 530 together into the input of another so that you can have complex combination functions. The behaviors 530 are intended to implement manageable portions of the total cognizance of the robot 100.

In the example shown, the behavior system 510a includes an obstacle detection/obstacle avoidance (ODOA) behavior 530a for determining responsive robot actions based on obstacles perceived by the sensor (e.g., turn away; turn around; stop before the obstacle, etc.). A person follow behavior 530b may be configured to cause the drive system 200 to follow a particular person based on sensor signals of the sensor system 400 (providing a local sensory perception). A speed behavior 530c (e.g., a behavioral routine executable on a processor) may be configured to adjust the speed setting of the robot 100 and a heading behavior 530d may be configured to alter the heading setting of the robot 100. The speed and heading behaviors 530c, 530d may be configured to execute concurrently and mutually independently. For example, the speed behavior 530c may be configured to poll one of the sensors (e.g., the set(s) of proximity sensors 410), and the heading behavior 530d may be configured to poll another sensor (e.g., a proximity sensor 410, such as a kinetic bump sensor 411 (FIG. 3A)). An aiming behavior 530e may be configured to move the robot 100 or portions thereof to aim one or more imaging sensors 450 toward a target or move the imaging sensor(s) 450 to gain an increased field of view 452 of an area about the robot 100.

Referring to FIGS. 6A and 6B, in some implementations, the robot 100 (via the aiming behavior 530e executing on the controller 500 or the sensor system 400) moves or pans the imaging sensor(s) 450, 450a-c to gain view-ability of the corresponding dead zone(s) 453. An imaging sensor 450 can be pointed in any direction 360 degrees (+/−180 degrees) by moving its associated imaging axis 455. In some examples, the robot 100 maneuvers itself on the ground to move the imaging axis 455 and corresponding field of view 452 of each imaging sensor 450 to gain perception of the volume of space once in a dead zone 453. For example, the robot 100 may pivot in place, holonomically move laterally, move forward or backward, or a combination thereof. In additional examples, if the imaging sensor 450 has a limited field of view 452 and/or detection field 457, the controller 500 or the sensor system 400 can actuate the imaging sensor 450 in a side-to-side and/or up and down scanning manner to create a relatively wider and/or taller field of view to perform robust ODOA. Panning the imaging sensor 450 (by moving the imaging axis 455) increases an associated horizontal and/or vertical field of view, which may allow the imaging sensor 450 to view not only all or a portion of its dead zone 453, but the dead zone 453 of another imaging sensor 450 on the robot 100.

In some examples, each imaging sensor 450 has an associated actuator moving the imaging sensor 450 in the scanning motion. In additional examples, the imaging sensor 450 includes an associated rotating mirror, prism, variable angle micro-mirror, or MEMS mirror array to increase the field of view 452 and/or detection field 457 of the imaging sensor 450.

In the example shown in FIG. 6B, the torso 130 pivots about the Z-axis on the base 120, allowing the robot 100 to move an imaging sensor 450 disposed on the torso 130 with respect to the forward drive direction F defined by the base 120. An actuator 138 (such as a rotary actuator) in communication with the controller 500 rotates the torso 130 with respect to the base 120. The rotating torso 130 moves the imaging sensor 450 in a panning motion about the Z-axis providing up to a 360° field of view 452 about the robot 100. The robot 100 may pivot the torso 130 in a continuous 360 degrees or +/− an angle ≧180 degrees with respect to the forward drive direction F.

With continued reference to the example shown in FIG. 6B, the robot 100 may include at least one long range sensor 650 arranged and configured to detect an object 12 relatively far away from the robot 100 (e.g., >3 meters). The long range sensor 650 may be an imaging sensor 450 (e.g., having optics or a zoom lens configured for relatively long range detection). In additional examples, the long range sensor 650 is a camera (e.g., with a zoom lens), a laser range finder, LIDAR, RADAR, etc. Detection of far off objects allows the robot 100 (via the controller 500) to execute navigational routines to avoid the object, if viewed as an obstacle, or approach the object, if viewed as a destination (e.g., for approaching a person 20 for capturing an image 50 or video of the person 20). Awareness of objects outside of the field of view of the imaging sensor(s) 450 on the robot 100 allows the controller 500 to avoid movements that may place the detected object 12 in a dead zone 453. Moreover, in person following routines, when a person 20 moves out of the field of view of an imaging sensor 450, the long range sensor 650 may detect the person 20 and allow the robot 100 to maneuver to regain perception of the person 20 in the field of view 452 of the imaging sensor 450. In some implementations, in image or video capturing routines, the robot 100 maneuvers to maintain continuous alignment of the imaging or long-range sensors 450, 650 on a person 20 such that perception of the person 20 is continuously in the field of view 452 of the imaging or long-range sensors 450, 650.

Referring to FIGS. 7A and 7B, in some implementations, while patrolling the environment 10, the robot 100 needs to scan the imaging sensor(s) 450 from side to side and/or up and down to detect a person 20 around an occlusion 16. In the examples shown, the person 20 and a wall 18 create the occlusion 16 within the field of view 452 of the imaging sensor 450. Moreover, the field of view 452 of the imaging sensor 450 having a viewing angle θv of less than 360 can be enlarged to 360 degrees by optics, such as omni-directional, fisheye, catadioptric (e.g., parabolic mirror, telecentric lens), panamorph mirrors and lenses.

The controller 500 may use imaging data 50 from the imaging sensor 450 for color/size/dimension blob matching. Identification of discrete objects (e.g., walls 18, person(s) 20, furniture, etc.) in a scene 10 about the robot 100 allows the robot 100 to not only avoid collisions, but also to search for people 20, 20a-b. The human interface robot 100 may need to identify target objects and humans 20, 20a-b against the background of the scene 10. The controller 500 may execute one or more color map blob-finding algorithms on the depth map(s) derived from the imaging data 50 of the imaging sensor 450 as if the maps were simple grayscale maps and search for the same “color” (that is, continuity in depth) to yield continuous portions of the image 50 corresponding to people 20 in the scene 10. Using color maps to augment the decision of how to segment people 20 would further amplify object matching by allowing segmentation in the color space as well as in the depth space. The controller 500 may first detect objects or people 20 by depth, and then further segment the objects 12 by color. This allows the robot 100 to distinguish between two objects (e.g., wall 18 and person 20) close to or resting against one another with differing optical qualities.

In implementations where the sensor system 400 includes only one imaging sensor 450 (e.g., camera) for object detection, the imaging sensor 450 may have problems imaging surfaces in the absence of scene texture and may not be able to resolve the scale of the scene. Using or aggregating two or more imaging sensors 450 for object detection can provide a relatively more robust and redundant sensor system 400. The controller 500 may use detection signals from the imaging sensor 450 and/or other sensors of the sensor system 400 to identify a person 20, determine a distance of the person 20 from the robot 100, construct a 3D map of surfaces of the person 20 and/or the scene 10 about the person 20, and construct or update an occupancy map 700.

As shown in FIGS. 7A and 7B, in some circumstances, the robot 100 receives an occupancy map 700 (e.g., from the security system 1000) of objects including walls 18 in a patrolling scene 10 and/or a patrolling area 5, or the robot controller 500 produces (and may update) the occupancy map 700 based on image data and/or image depth data received from an imaging sensor 450 over time. In addition to localization of the robot 100 in the patrolling scene 10 (e.g., the environment about the robot 100), the robot 100 may patrol by travelling to other points in a connected space (e.g., the patrolling area 5) using the sensor system 400. The robot 100 may include a short range type of imaging sensor 450 (e.g., the first imaging sensor 450a of the sensor module 300 (FIG. 3B) aimed downward toward the floor surface 5) for mapping the scene 10 about the robot 100 and discerning relatively close objects 12 or people 20. The robot 100 may include a long range type of imaging sensor 450 (e.g., the second imaging sensor 450b of the sensor module 300 aimed away from the robot 100 and substantially parallel to the floor surface 5, shown in FIG. 3B) for mapping a relatively larger area about the robot 100 and discerning a relatively far away person 20. The robot 100 may include a camera 168 (mounted on the head 160, as shown in FIGS. 1B and 1F) for mapping a relatively larger area about the robot 100 and discerning a relatively far away person 20. The robot 100 can use the occupancy map 700 to identify and detect people 20 in the scene 10 as well as occlusions 16 (e.g., wherein objects cannot be confirmed from the current vantage point). For example, the robot 100 may compare the occupancy map 700 against sensor data received from the sensor system 400 to identify an unexpected stationary or moving object 12 in the scene 10 and then identify that object 12 as a person 20. The robot 100 can register an occlusion 16 or wall 18 in the scene 10 and attempt to circumnavigate the occlusion 16 or wall 18 to verify a location of new person 20, 20a-b or other object in the occlusion 16. The robot 100 can register the occlusion 16 or person 20 in the scene 10 and attempt to follow and/or capture a clear still image 50 or video of the person 20. Moreover, using the occupancy map 700, the robot 100 can determine and track movement of a person 20 in the scene 10. For example, using the imaging sensor 450, the controller 500 may detect movement of the person 20 in the scene 10 and continually update the occupancy map 700 with a current location of the identified person 20.

When the robot 100 detects a moving object 12 (via the sensor system 400), the robot 100 may send a surveillance report 1010 to the remote security system 1000, regardless of whether the robot 100 can resolve the object 12 as a person 20 or not. The security system 1000 may execute one or more routines (e.g., image analysis routines) to determine whether the object 12 is a person 20, a hazard, or something else. Moreover, a user of the security system 1000 may review the surveillance report 1010 to determine the nature of the object 12. For example, sensed movement could be due to non-human actions, such as a burst water pipe, a criminal mobile robot, or some other moving object of interest.

In some implementations, a second person 20b of interest, located behind the wall 18 in the scene 10, may be initially undetected in an occlusion 16 of the scene 10. An occlusion 16 can be an area in the scene 10 that is not readily detectable or viewable by the imaging sensor 450. In the example shown, the sensor system 400 (e.g., or a portion thereof, such as the imaging sensor 450) of the robot 100 has a field of view 452 with a viewing angle θ_{V} (which can be any angle between 0 degrees and 360 degrees) to view the scene 10. In some examples, the imaging sensor 450 includes omni-directional optics for a 360 degree viewing angle θ_{V}; while in other examples, the imaging sensor 450, 450a, 450b has a viewing angle θ_{V} of less than 360 degrees (e.g., between about 45 degrees and 180 degrees). In examples where the viewing angle θ_{V} is less than 360 degrees, the imaging sensor 450 (or components thereof) may rotate with respect to the robot body 110 to achieve a viewing angle θ_{V} of 360 degrees. The imaging sensor 450 may have a vertical viewing angle θ_{V-V} the same as or different from a horizontal viewing angle θ_{V-H}. For example, the imaging sensor 450 may have a horizontal field of view θ_{v-H} of at least 45 degrees and a vertical field of view θ_{V-V} of at least 40 degrees. In some implementations, the imaging sensor 450 can move with respect to the robot body 110 and/or drive system 200. Moreover, in order to detect the second person 20b and capture a still image 50 and/or video of the second person 20b, the robot 100 may move the imaging sensor 450 by driving about the patrolling scene 10 in one or more directions (e.g., by translating and/or rotating on the patrolling surface 5) to obtain a vantage point that allows detection and perception of the second person 20b in the field of view 452 of the imaging sensor 450. In some implementations, in image or video capturing routines, the robot 100 maneuvers to maintain continuous alignment of the imaging or long-range sensors 450, 650 such that perception of the person 20 is continuously in the field of view 452, 652 of the imaging or long-range sensors 450, 650. Robot movement or independent movement of the imaging sensor(s) 450, 650 may resolve monocular difficulties as well.

The controller 500 may assign a confidence level to detected locations or tracked movements of people 20 in the scene 10. For example, upon producing or updating the occupancy map 700, the controller 500 may assign a confidence level for each person 20 on the occupancy map 700. The confidence level can be directly proportional to a probability that the person 20 is actually located in the patrolling area 5 as indicated on the occupancy map 700. The confidence level may be determined by a number of factors, such as the number and type of sensors used to detect the person 20. The imaging sensor 450 may provide a different level of confidence, which may be higher than the proximity sensor 410. Data received from more than one sensor of the sensor system 400 can be aggregated or accumulated for providing a relatively higher level of confidence over any single sensor. In some examples, the controller 500 compares new image depth data with previous image depth data (e.g., the occupancy map 700) and assigns a confidence level of the current location of the person 20 in the scene 10. The sensor system 400 can update location confidence levels of each person 20, 20a-b after each imaging cycle of the sensor system 400. When the controller 500 identifies that the location of a person 20 has changed (e.g., is no longer occupying the corresponding location on the occupancy map 700), the controller 500 may identify that person 20 as an “active” or “moving” person 20 in the scene 10.

Odometry is the use of data from the movement of actuators to estimate change in position over time (distance traveled). In some examples, an encoder is disposed on the drive system 200 for measuring wheel revolutions, therefore a distance traveled by the robot 100. The controller 500 may use odometry in assessing a confidence level for an object or person location. In some implementations, the sensor system 400 includes an odometer and/or an angular rate sensor (e.g., gyroscope or the IMU 470) for sensing a distance traveled by the robot 100. A gyroscope is a device for measuring or maintaining orientation based on the principles of conservation of angular momentum. The controller 500 may use odometry and/or gyro signals received from the odometer and/or angular rate sensor, respectively, to determine a location of the robot 100 in a working area 5 and/or on an occupancy map 700. In some examples, the controller 500 uses dead reckoning. Dead reckoning is the process of estimating a current position based upon a previously determined position, and advancing that position based upon known or estimated speeds over elapsed time, and course. By knowing a robot location in the patrolling area 5 (e.g., via odometry, gyroscope, etc.) as well as a sensed location of one or more people 20 in the patrolling area 5 (via the sensor system 400), the controller 500 can assess a relatively higher confidence level of a location or movement of a person 20 on the occupancy map 700 and in the working area 5 (versus without the use of odometry or a gyroscope).

Odometry based on wheel motion can be electrically noisy. The controller 500 may receive image data from the imaging sensor 450 of the environment or scene 10 about the robot 100 for computing robot motion, through visual odometry. Visual odometry may entail using optical flow to determine the motion of the imaging sensor 450. The controller 500 can use the calculated motion based on imaging data of the imaging sensor 450 for correcting any errors in the wheel based odometry, thus allowing for improved mapping and motion control. Visual odometry may have limitations with low-texture or low-light scenes 10 if the imaging sensor 450 cannot track features within the captured image(s).

Other details and features on odometry and imaging systems, which may be combinable with those described herein, can be found in U.S. Pat. No. 7,158,317 (describing a “depth-of field” imaging system), and U.S. Pat. No. 7,115,849 (describing wavefront coding interference contrast imaging systems), the contents of which are hereby incorporated by reference in their entireties.

Referring to FIGS. 5 and 7B, in some implementations, the behavior system 510a includes a person follow behavior 530b. While executing this behavior 530b, the robot 100 may detect, track, and follow a person 20. The person follow behavior 530b allows the robot 100 to observe or monitor the person 20, for example, by capturing images 50 (e.g., still images 50 and/or video) of the person 20 using the imaging sensor(s) 450. Additionally, the controller 500 may execute the person follow behavior 530b to maintain a continuous perception of the person 20 within the field of view 452 of the imaging sensor 450 to obtain a human recognizable/clear image and/or video, which can be used to identify the person 20 and actions of the person 20. The behavior 530b may cause the controller 500 to aim one or more imaging sensors 168, 450, 450a-c at the perceived person 20. The controller 500 may use image data from the third imaging sensor 450c of the sensor module 300, which is arranged to have its imaging axis 455c arranged to aim upward and away from the torso 130, to identify people 20. The third imaging sensor 450c can be arranged to capture images of the face of an identified person 20. In implementations where the robot 100 has an articulated head 160 with a camera 168 and/or other imaging sensor 450 on the head 160, as shown in FIG. 2G, the robot 100 may aim the camera 168 and/or other imaging sensor 450 via the neck 150 and head 160 to capture images 50 of an identified person 20 (e.g., images 50 of the face of the person 20). The robot 100 may maintain the field of view 452 of the imaging sensor 168, 450 on the followed person 20. Moreover, the drive system 200 can provide omni-directional and/or holonomic motion to control the robot 100 about planar, forward/back, and rotational directions x, y, and θz, respectively, to orient the imaging sensor 168, 450 to maintain the corresponding field of view 452 on the person 20. The robot 100 can drive toward the person 20 to keep the person 20 within a threshold distance range D_{R} (e.g., corresponding to a sensor field of view 452). In some examples, the robot 100 turns to face forward toward the person 20 while tracking the person 20. The robot 100 may use velocity commands and/or waypoint commands to follow the person 20. In some examples, the robot 100 orients the imaging sensor 168, 450 to capture a still image and/or video of the person 20.

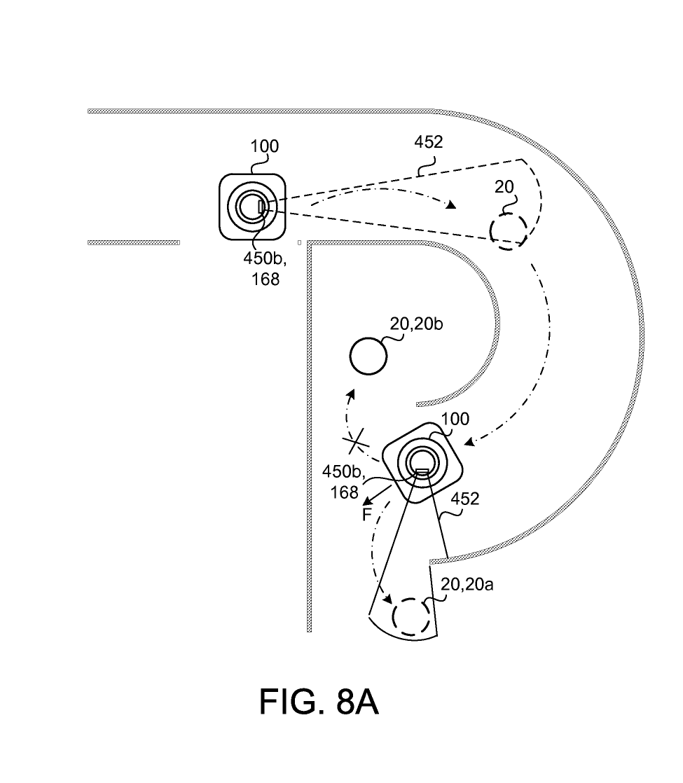

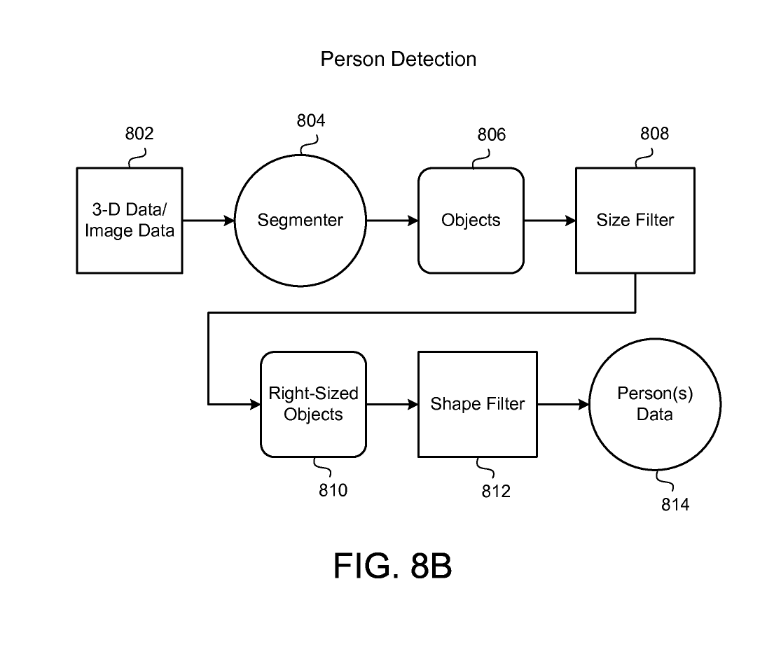

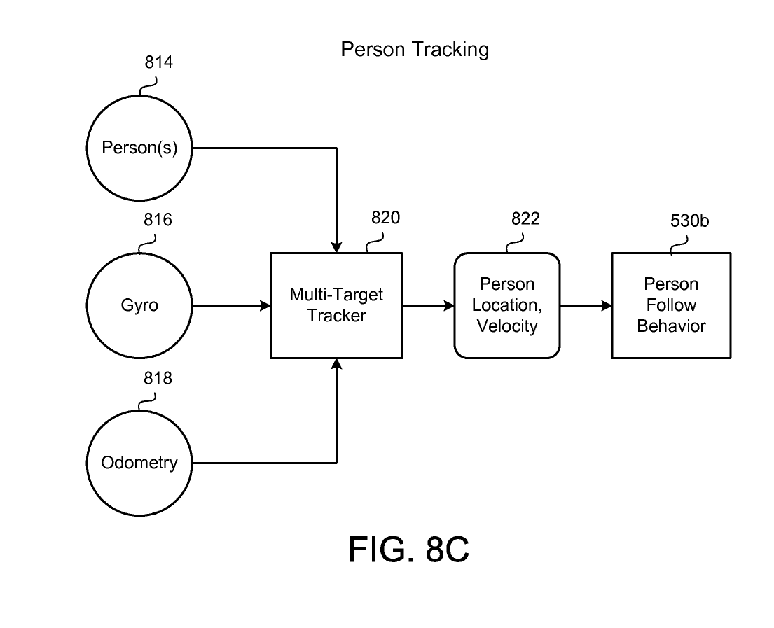

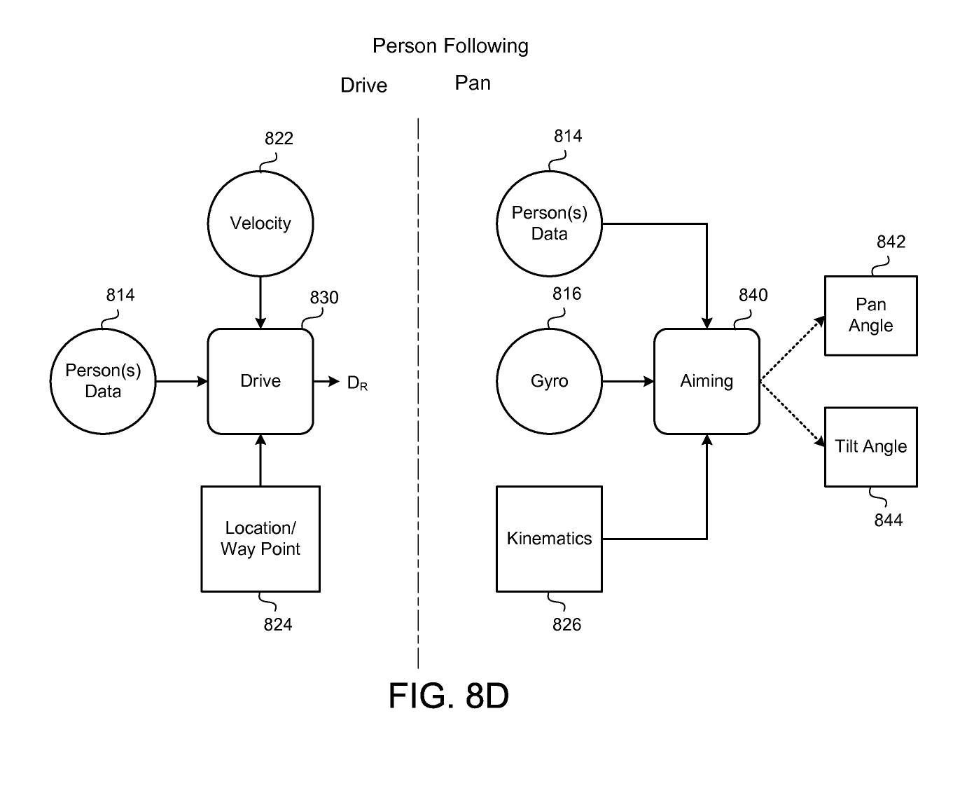

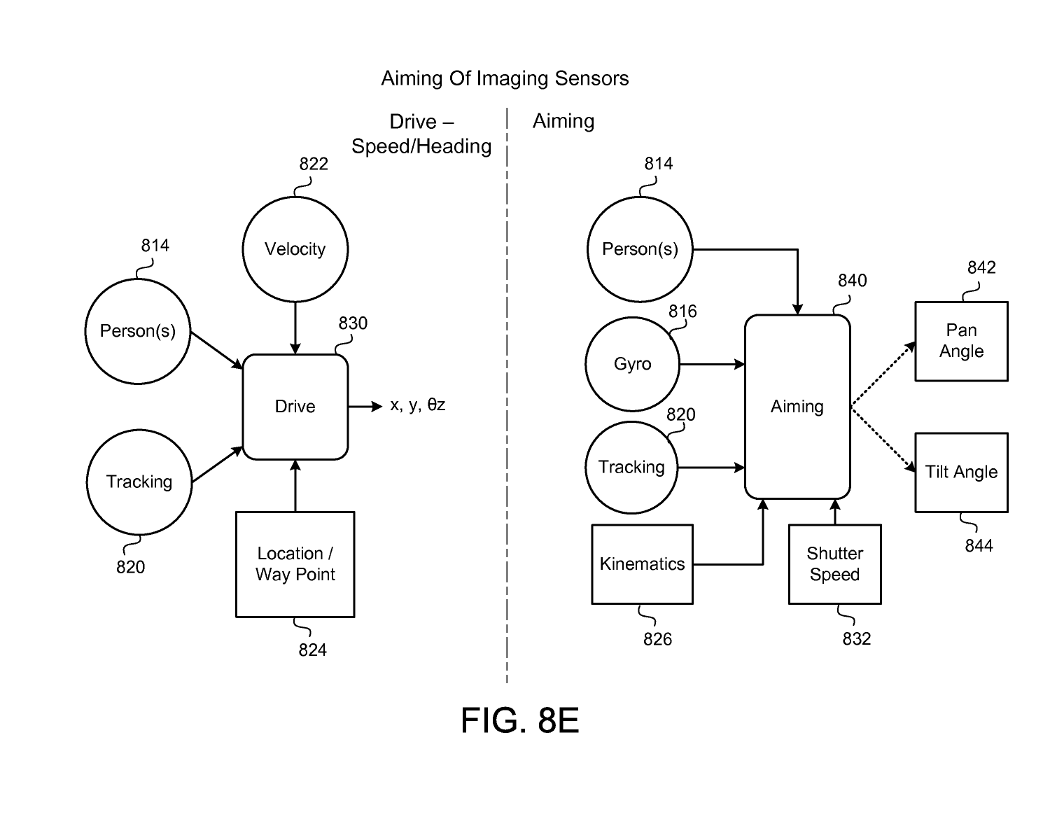

Referring to FIG. 8A, a naïve implementation of person following would result in the robot 100 losing the location of a person 20 once the person 20 has left the field of view 452 of the imaging sensor 450. One example of this is when the person 20 goes around a corner. To work around this problem, the robot 100 retains knowledge of the last known location of the person 20, determines which direction the person 20 is heading and estimates the trajectory of the person 20. The robot 100 may move toward the person 20 to determine the direction of movement and rate of movement of the person 20 with respect to the robot 100, using the visual data of the imaging sensor(s) 450. The robot 100 can navigate to a location around the corner toward the person 20 by using a waypoint (or set of waypoints), coordinates, an imaged target of the imaging sensor 450, an estimated distance, dead reckoning, or any other suitable method of navigation. Moreover, as the robot 100 detects the person 20 moving around the corner, the robot 100 can drive (e.g., in a holonomic manner) and/or move the imaging sensor 450 (e.g., by panning and/or tilting the imaging sensor 450 or a portion of the robot body 110 supporting the imaging sensor 450) to orient the field of view 452 of the imaging sensor 450 to regain viewing of the person 20, for example, to capture images 50 of the person 20 and/or observe or monitor the person 20.

Referring to FIGS. 8A and 8B, using the image data received from the image sensor(s) 450, the control system 510 can identify the person 20, 20a (e.g., by noticing a moving object and assuming the moving object is the person 20, 20a when the object meets a particular height range, or via pattern or image recognition), so as to continue following that person 20. If the robot 100 encounters another person 20b, as the first person 20a turns around a corner, for example, the robot 100 can discern that the second person 20b is not the first person 20a and continues following the first person 20a. In some implementations, to detect a person 20 and/or to discern between two people 20, the image sensor 450 provides image data and/or 3-D image data 802 (e.g., a 2-d array of pixels, each pixel containing depth information) to a segmentor 804 for segmentation into objects or blobs 806. For example, the pixels are grouped into larger objects based on their proximity to neighboring pixels. Each of these objects (or blobs) is then received by a size filter 808 for further analysis. The size filter 808 processes the objects or blobs 806 into right sized objects or blobs 810, for example, by rejecting objects that are too small (e.g., less than about 3 feet in height) or too large to be a person 20 (e.g., greater than about 8 feet in height). A shape filter 812 receives the right sized objects or blobs 810 and eliminates objects that do not satisfy a specific shape. The shape filter 812 may look at an expected width of where a midpoint of a head is expected to be using the angle-of-view of the camera 450 and the known distance to the object. The shape filter 812 processes are renders the right sized objects or blobs 810 into person data 814 (e.g., images or data representative thereof). The control system 510 may use the person data 814 as a unique identifier to discern between two people 20 detected near each other, as discussed below.

In some examples, the robot 100 can detect and track multiple persons 20, 20a-b by maintaining a unique identifier for each person 20, 20a-b detected. The person follow behavior 530b propagates trajectories of each person 20 individually, which allows the robot 100 to maintain knowledge of which person(s) 20 the robot 100 should track, even in the event of temporary occlusions 16 caused by other persons 20 or objects 12, 18.

Referring to FIG. 8C, in some implementations, a multi-target tracker 820 (e.g., a routine executable on a computing processor, such as the controller 500) receives the person(s) data 814 (e.g., images or data representative thereof) from the shape filter 812, gyroscopic data 816 (e.g., from the IMU 470), and odometry data 818 (e.g., from the drive system 200) provides person location/velocity data 822, which is received by the person follow behavior 530b. In some implementations, the multi-target tracker 820 uses a Kalman filter to track and propagate each person's movement trajectory, allowing the robot 100 to perform tracking beyond a time when a user is seen, such as when a person 20 moves around a corner or another person 20 temporarily blocks a direct view to the person 20.

Referring to FIG. 8D, in some examples, the person follow behavior 530b causes the controller 500 to move in a manner that allows the robot 100 to capture a clear picture of a followed person 20. For example, the robot 100 may: (1) maintain a constant following distance D_{R} between the robot 100 and the person 20 while driving; (2) catch up to a followed person 20 (e.g., to be within a following distance D_{R} that allows the robot 100 to capture a clear picture of the person 20 using the imaging sensor 450); (3) speed past the person 20 and then slow down to capture a clear picture of the person 20 using the imaging sensor 450.

The person follow behavior 530b can be divided into two subcomponents, a drive component 830 and an aiming component 840. The drive component 830 (e.g., a follow distance routine executable on a computing processor) may receive the person data 814, person velocity data 822, and location data 824 (e.g., waypoints, coordinates, headings, distances to objects, etc. of the robot 100) to determine (e.g., via the computing processor) the following distance D_{R} (which may be a range). The drive component 830 controls how the robot 100 may try to achieve its goal, depending on the distance to the person 20. If the robot 100 is within a threshold distance, velocity commands are used directly, allowing the robot 100 to maintain the following distance D_{R} or some other distance that allows the robot 100 to capture a clear picture of the person 20 using the imaging sensor 450. If the person 20 is further than the desired distance, the controller 500 may use the location data 824 to move closer to the person 20. The drive component 830 may further control holonomic motion of the robot 100 to maintain the field of view 452 of the image sensor 450 (e.g., of the sensor module 300 and/or the head 160), on the person 20 and/or to maintain focus on the person 20 as the robot 100 advances toward or follows the person 20.

The aiming component 840 causes the controller 500 to move the imaging sensor 450 or a portion of the robot body 110 supporting the imaging sensor 450 to maintain the field of view 452 of the image sensor 450 on the person 20. In examples where the robot 100 includes an interface module 140, the controller 500 may actuate the neck 150 to aim the camera 168 or the imaging sensor on the head 160 toward the person 20. In additional examples, the controller 500 may rotate the sensor module 300 on the torso 130 to aim one of the imaging sensors 450a-c of the sensor module 300 toward the person 20. The aiming routine 840 (e.g., executable on a computing processor) may receive the person data 814, the gyroscopic data 816, and kinematics 826 (e.g., from the dynamics model 560 of the control system 510) and determine a pan angle 842 and/or a tilt angle 844, as applicable to the robot 100 that may orient the image sensor 450 to maintain its field of view 452 on the person 20. There may be a delay in the motion of the base 120 relative to the pan-tilt of the head 160 and also a delay in sensor information arriving to the person follow behavior 530b. This may be compensated for based on the gyro and odometry information 816, 818 so that the pan angle θ_{R} does not overshoot significantly once the robot 100 is turning.

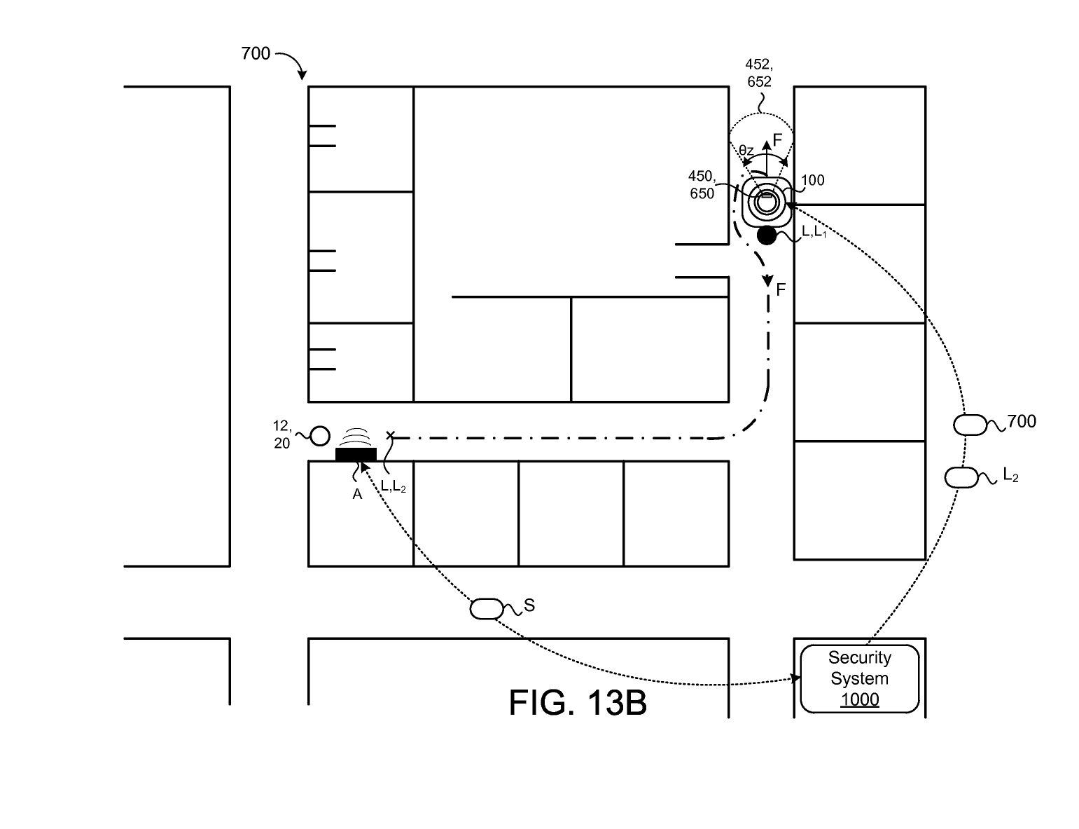

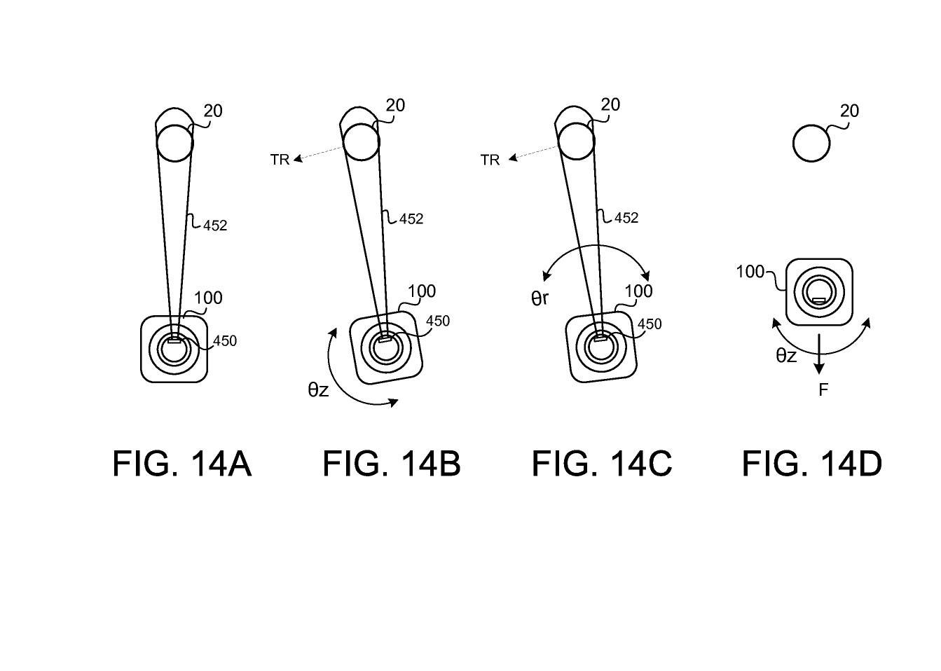

Referring to FIG. 8E, in some examples, the controller 500 uses the behavior system 510a to execute the aiming behavior 530e to aim the corresponding field of view 452, 652 of at least one imaging sensor 450, 650 to continuously perceive a person 20 within the field of view 452, 652. In some examples, the aiming behavior 530e (via the controller 500) aims the field of view 452, 652 to perceive a facial region of the person 20. In some examples, a person 20 is moving while the image sensor(s) 450, 650 capture images 50. Due to the movement by the person 20, in addition to the focal range and shutter speed of the imaging sensor 450, 650 and dynamics of the robot 100 (e.g., velocity/holonomic motion), the person 20 may not be centered in the captured image 50 or the image 50 may be blurred. If the person 20 is not centered in the captured image 50 and/or the image 50 is blurred, the person 20 may not be recognizable. Accordingly, the aiming behavior 530e factors in a movement trajectory TR (e.g., as shown in FIG. 14B) of the person 20 and the planar velocity of the robot 100. Using the movement trajectory TR and/or the planar velocity of the robot 100, the controller 500 may command movement of the robot 100 (via the drive system 200) and/or movement of a portion of the robot body 110 (e.g., torso 130, sensor module 300, and/or interface module 140) to aim of the imaging sensor 450, 650 to maintain the corresponding field of view 452, 652 on the identified person 20. In some examples, the command is a drive command at a velocity proportional to the movement trajectory TR of the identified person 20. In examples where the robot 100 includes the interface module 140, the command may include a pan/tilt command of the neck 150 at a velocity proportional to a relative velocity between the person 20 and the robot 100. The controller 500 may additionally or alternatively command (e.g., issue drive commands to the drive system 200) the robot 100 to move in a planar direction with three degrees of freedom (e.g., holonomic motion) while maintaining the aimed field of view 452, 652 of the imaging sensor 450, 650 on the identified person 20 associated with the movement trajectory. The robot 100 knows its limitations (e.g., how fast the robot 100 can decelerate from a range of travel speeds) and can calculate how quickly the drive system 200 needs to advance and then decelerate/stop to capture one or more images 50 with the image sensor(s) 450 mounted on the robot 100. Moreover, the robot 100 may pace the moving object 12 (e.g., the person 20) to get a rear or sideways image of the moving object 12.

The aiming behavior 530e, for aiming the image sensor(s) 450, 650, can be divided into two subcomponents, a dive component 830 and an aiming component 840. The dive component 830 (a speed/heading routine executable on a computing processor) may receive the person data 814 (FIG. 8B), person tracking (e.g., trajectory) data 820 (FIG. 8B), person velocity data 822 (FIG. 8C), and location data 824 (FIG. 8C) to determine drive commands (e.g., holonomic motion commands) for the robot 100. For example, the controller 500 may command the robot 100 to move in a planar direction of the three planar velocities (forward/back, lateral, and rotational) x, y, and θz, respectively, for aiming the field of view 452, 652 of the image device 450, 650 to continuously perceive the person 20 in the field of view 452, 652. The person 20 may be in motion or stationary. In some examples, the drive routine 830 can issue drive commands to the drive system 200, causing the robot 100 to drive away from the person 20 once an acceptable image and/or video is captured. In other examples, the robot 100 continues following the person 20, using the person follow behavior 530b, and sends one or more surveillance reports 1010 (e.g., time stamped transmissions with trajectory calculations) to the security system 1000 until the person 20 is no longer trackable. For example, if the person 20 goes through a stairwell door, the robot 100 may send a surveillance report 1010 to the security system 1000 that includes a final trajectory prediction TR of the person 20 and/or may signal stationary stairwell cameras or robots on other adjacent floors to head toward the stairwell to continue tracking the moving person 20.

The aiming component 840 causes movement of the robot 100 (via the drive system 200) and/or portions of the robot 100 (e.g., rotate the sensor module 300, pan and/or tilt the neck 150) to aim the field of view 452, 652 of the image device 450, 650 to continuously perceive the person 20 in the field of view 452, 652. In some examples, the aiming component 840 aims the field of view 452, 652 independent of the drive component 830. For example, the controller 500 may decide to only utilize the aiming component 840 to aim the field of view 452, 652. In other examples, the controller 500 utilizes both the aiming component 840 and the drive component 830 to aim the field of views 452, 652 on the person 20. The aiming component 840 (e.g., executable on a computing processor) may receive the person data 814 (FIG. 8B), the person tracking (e.g., trajectory) data 820 (FIG. 8B), the gyroscopic data 816 (FIG. 8C), kinematics 826 (e.g., from the dynamics model 560 of the control system 510), and shutter speed data 832 (e.g., from the imaging sensor(s) 450, 650) and determine an appropriate movement command for the robot 100. In examples where the robot 100 includes the interface module 140, the movement command may include a pan angle 842 and/or a tilt angle 844 that may translate the imaging sensor 450, 650 to maintain its field of view 452, 652 to continuously perceive the person 20. The aiming component 840 may determine a velocity at which the pan angle 842 and the tilt angle 844 translate proportional to the movement trajectory TR of the person 20 so that the field of view 452, 652 does not undershoot or overshoot a moving person 20, thereby safeguarding the person is centered in an image (or video) captured by the at least one imaging sensor 450, 650. There may be a delay in the motion of the base 120 relative to the pan-tilt of the head 160 and also a delay in sensor information arriving to the behavior system 510a. This may be compensated for based on the gyro and odometry information 816, 818 so that the pan angle θ_{R} does not overshoot significantly once the robot is turning.

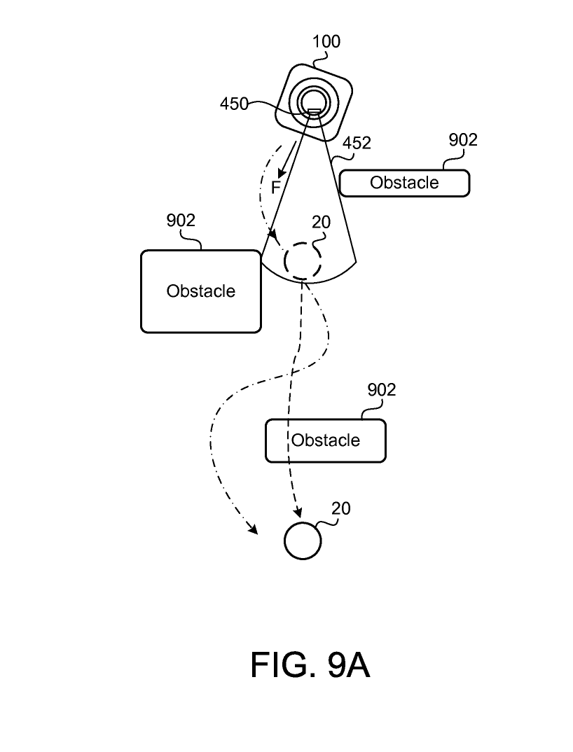

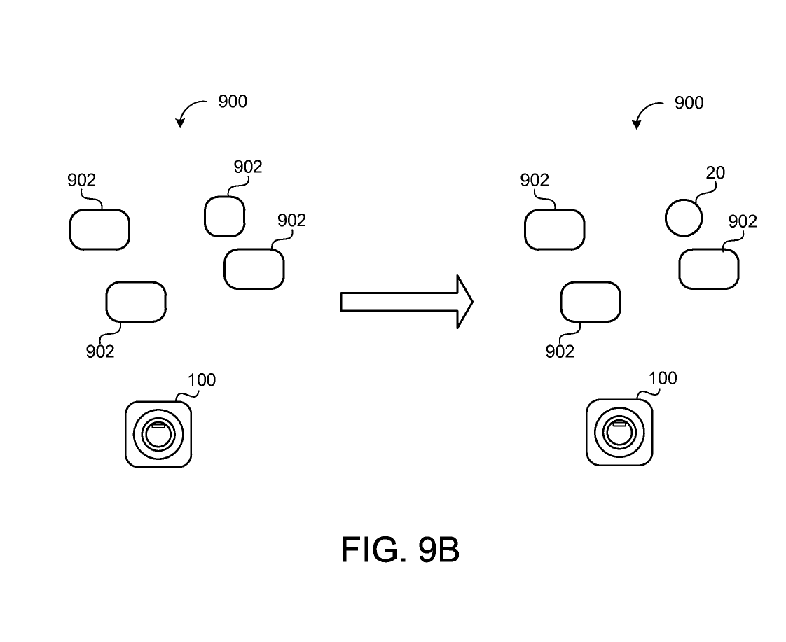

Referring to FIG. 9A, in some examples, the person follow behavior 530b causes the robot 100 to navigate around obstacles 902 to continue following the person 20. The person follow behavior 530b may consider a robot velocity and robot trajectory in conjunction with a person velocity and a person direction of travel, or heading, to predict a future person velocity and a future person trajectory on a map of the environment, such as the occupancy map 700 (either a pre-loaded map stored in the robot memory or stored in a remote storage database accessible by the robot over a network, or a dynamically built map established by the robot 100 during a mission using simultaneous localization and mapping (SLAM)). The robot 100 may also use an ODOA (obstacle detection/obstacle avoidance) behavior 530a to determine a path around obstacles 902, while following the person 20, for example, even if the person 20 steps over obstacles 902 that the robot 100 cannot traverse. The ODOA behavior 530a (FIG. 5) can evaluate predicted robot paths (e.g., a positive evaluation for predicted robot path having no collisions with detected objects). The control arbitration system 510b can use the evaluations to determine the preferred outcome and a corresponding robot command (e.g., drive commands).

Referring to FIGS. 9A and 9B, in some implementations, the control system 510 builds a local map 900 of obstacles 902 in an area near the robot 100. The robot 100 distinguishes between a real obstacle 902 and a person 20 to be followed, thereby enabling the robot 100 to travel in the direction of the person 20. A person-tracking algorithm can continuously report to the ODOA behavior 530a a location of the person 20 being followed. Accordingly, the ODOA behavior 530a can then update the local map 900 to remove the obstacle 902 previously corresponding to the person 20 and can optionally provide the current location of the person 20.

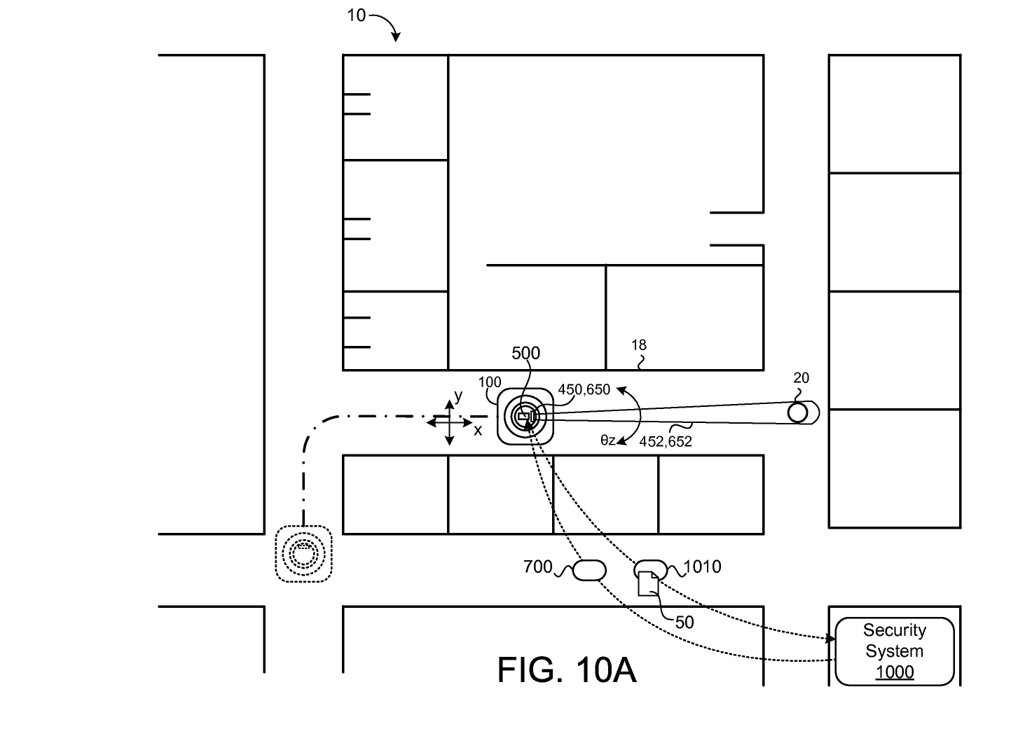

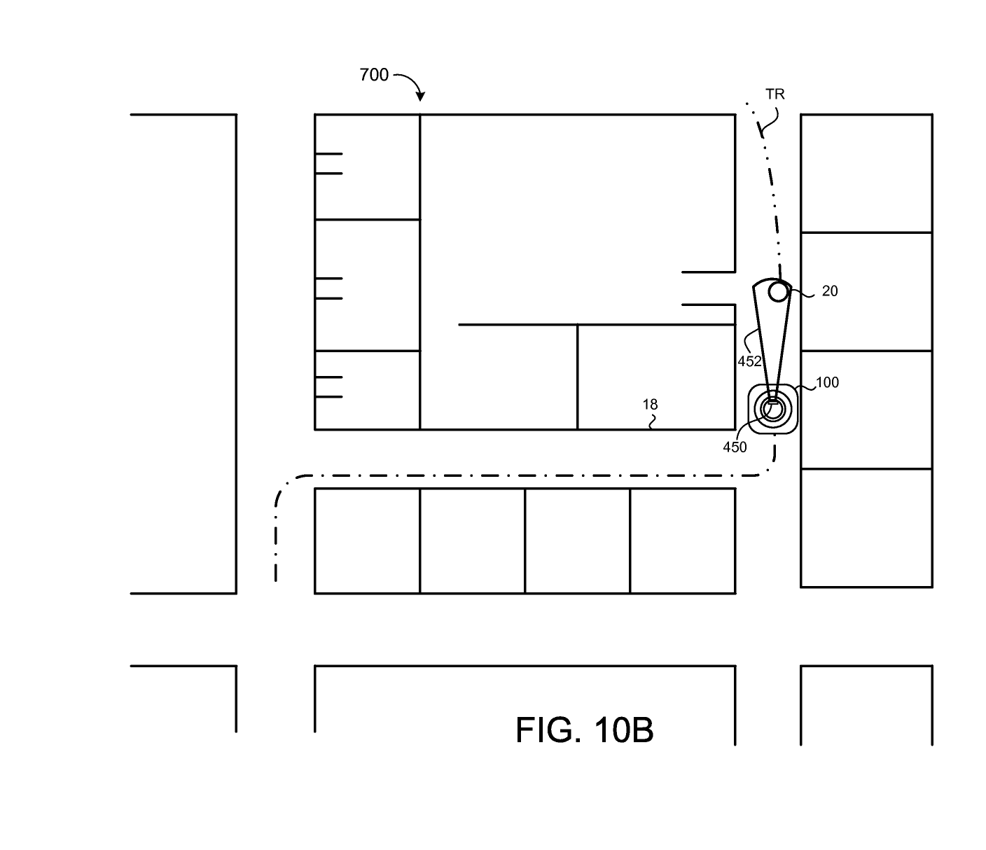

Referring to FIGS. 10A and 10B, in some implementations, the robot 100 monitors a patrolling environment 10 of a facility for unauthorized persons 20. In some examples, the security system 1000 or some other source provides the patrolling robot 100 with a map 700 (e.g., an occupancy or layout map) of the patrolling environment 10 for autonomous navigation. In other examples, the robot 100 builds a local map 900 using SLAM and sensors of the sensor system 400, such as the camera 168, the imaging sensors 450, 450a-c, infrared proximity sensors 410, laser scanner 440, IMU 470, sonar sensors, drive motors 220a-d, the panning motor 330, as described above in reference to the robot base 120 sensor module 300, and/or the head 160. For example, in a facility, such as an office building, the robot 100 may need to know the location of each room, entrances and hallways. The layout map 700 may include fixed obstacles 18, such as walls, hallways, and/or fixtures and furniture. In some implementations, the robot 100 receives the layout map 700 and can be trained to learn the layout map 700 for autonomous navigation.

The controller 500 may schedule patrolling routines for the robot 100 to maneuver between specific locations or control points on the layout map 700. For example, while patrolling around the building, the robot 100 may record its position at specific locations on the layout map 700 at predetermined time intervals set forth by the patrolling routine schedule. While patrolling the environment 10, the robot 100 may capture image data (e.g., still images and/or video, 2D or 3D) along the field of view 452 of the imaging sensor(s) 450, at one or more specific locations set forth by the patrolling routine schedule. The robot 100 (via the controller 500) may tag the image data (e.g., tag each image and/or video) obtained with the corresponding location and time. The robot 100 may send a surveillance report 1010, such as that in FIG. 1B that includes the tagged images and/or video obtained during the patrolling routine to the security system 1000 upon completing the patrolling routine or instantaneously after obtaining each image 50 and/or video. For example, the robot 100 may communicate wirelessly over a network 102 to send emails, text messages, SMS messages and/or voice messages that include the time stamp data included in the message 1012, photographs 50, person trajectory TR, and/or location maps 700 included in the surveillance reports 1010 to the security system 1000 or a remote user, such as a smartphone device of a business owner whose business property is being patrolled by the robot 100.

In response to detecting a change in the environment 10 about the robot 100 using the sensor system 400 (e.g., detecting movement, noise, lighting changes, temperature changes, etc.), the robot 100 may deviate from a patrolling routine to investigate the detected change. For example, in response to the sensor module 300 detecting movement in the environment 10 about the robot 100 using one or more of the imaging sensors 450, 450a-c, the controller 500 may resolve a location on the layout map 700 of the sensed movement based on three-dimensional volumetric point cloud data of the imaging sensor(s) 450, 450a-c and command the drive system 200 to move towards that location to investigate a source of the movement. In some examples, the sensor module 300 rotates or scans about its collar axis C to identify environment changes; while in other examples, the sensor module 300 rotates or scans about its collar axis C after identification on an environment change, to further identify a source of the environment change.

The robot 100 may detect motion of an object by comparing a position of the object in relation to an occupancy map 700 (FIG. 7A) in successive images 50. Similarly, the robot 100 may detect motion of an object by determining that the object becomes occluded in subsequent images 50. In some examples, the robot 100 propagates a movement trajectory (FIG. 10C) using a Kalman filter. When object motion is detected, the control system 510 of the robot 100 may be prompted to determine whether or not the detected object in motion is a person 20 using the image data 50 received from the imaging sensor(s) 450. For example, as shown in FIG. 10B, the control system 510 may identify the person 20 based on the received image 50 and/or 3-D data and process person data 814 associated with the person 20.

In some implementations, the robot 100 uses at least one imaging sensor 168, 450 to capture a human recognizable still image and/or video of a person 20 based on the processed person data 814 associated with the person 20. For example, the controller 500 may command the robot 100 to maneuver holonomically and/or command rotation/pan/tilt of the neck 150 and head 160 of the robot 100 to aim the field of the view 452 of the imaging sensor 450 to perceive a facial region of the person 20 within the field of view 452 and snap a crisp photo for transmission to a remote recipient.

In additional implementations, sensors 410, 440, 450 positioned on the robot 100 at heights between 3-5 feet may simultaneously detect movement and determine that the object 12 extending between these ranges is a person 20. In still more implementations, the robot 100 may assume that a moving object 12 is a person 20, based on an average speed of a walking/running person (e.g., between about 0.5 mph and 12 mph).

The robot 100 may capture another image of the person 20 if a review routine executing on the control system 510 determines the person 20 is not recognizable (e.g., the person 20 is not centered in the image 50 or the image 50 is blurred). The controller 500 may tag a location and/or a time associated with the human recognizable image 50 of the person 20 and transmit the captured image 50 and associated location/time tags in the surveillance report 1010 to the security system 1000. In some implementations, the robot 100 chooses to track and/or follow the person 20 (FIG. 10B).

In order to investigate actions of a person 20, the controller 500 may execute one or more behaviors 530 to gain a vantage point of the person 20 sufficient to capture images 50 using the imaging sensor(s) 450 and/or other sensor data from other sensors of the sensor system 400. In some examples, the controller 500 tracks the person 20 by executing the person follow behavior 530b to propagate a movement trajectory TR of the person 20. As discussed above, the multi-target tracker 820 (FIG. 8C) may receive the person data 814 from the shape filter 812, gyroscopic data 816 (e.g., from the IMU 470), and odometry data 818 (e.g., from the drive system 200) to provide person location/velocity data 822, which is received by the person follow behavior 530b. The person follow behavior 530b may determine the movement trajectory TR of the person 20 once, periodically, continuously, or as the person follow behavior 530b determines that the followed person 20 has moved outside of the observed volume of space S. For example, when the followed person 20 moves outside of the observed volume of space S (e.g., around a corner), the person follow behavior 530b may determine the movement trajectory TR of the person 20, so as to move toward and continue to follow the person 20 from a vantage point that allows the robot 100 to capture images 50 of the person 20 using the imaging sensor(s) 450. The controller 500 may use the movement trajectory TR of the person 20 to move in a direction that the robot 100 perceived the person 20 was traveling when last detected by the sensor system 400.

Additionally, the robot 100 may employ the person follow behavior 530b to maintain a following distance D_{R} between the robot 100 and the person 20 while maneuvering across the floor surface 5 of the patrolling environment 10. The robot 100 may need to maintain the following distance D_{R} in order to capture a video of the person 20 carrying out some action without alerting the person 20 of the presence of the robot 100. As discussed above, the drive component 830 (FIG. 8D) may receive the person data 814, velocity data 822, and location data 824 to maintain the following distance D_{R} and control holonomic motion of the robot 100 to maintain the aimed field of view 452 of the image sensor 450 on the person 20. Additionally, the aiming component 840 (FIG. 8D) may receive the person data 814, the gyroscopic data 816, and kinematics 826 and determine a pan angle 842 and a tilt angle 844 that may maintain the aimed field of view 452 on the person 20. In some examples, the controller 500 navigates the robot 100 toward the person 20 based upon the trajectory TR propagated by the person follow behavior 530b. The controller 500 may accommodate for limitations of the imaging sensor 450 by maneuvering the robot 100 based on the trajectory TR of the person 20 to capture image data 50 (e.g., still images or video) of the person 20 along a field of view 452 of the imaging sensor 450. The controller 500 may account for dynamics of the person 20 (e.g., location, heading, trajectory, velocity, etc.), shutter speed of the imaging sensor 450 and dynamics of the robot 100 (e.g., velocity/holonomic motion) to aim the corresponding field of view 452 of the imaging sensor 450 to continuously perceive the person 20 within the field of view 452, so that the person 20 is centered in the captured image 50 and the image 50 is clear. Moreover, the controller 500 may execute movement commands to maneuver the robot 100 in relation to the location of the person 20 to capture a crisp image 50 of a facial region of the person 20, so that the person 20 is recognizable in the image 50.

The controller 500 may use the trajectory prediction TR of the person 20 to place the imaging sensor 450 (e.g., via drive commands and/or movement commands of the robot body 110) where the person 20 may be in the future, so that the robot 100 can be stationary at location ready to capture an image 50 of the person 20, as the person 20 passes by the robot 100. For example, when the person 20 is quickly passing close to the robot 100, the robot 100 may rotate, move, and stop ahead of the person 20 along the predicted trajectory TR of the person 20 to be nearly still when the person 20 enters the field of view 452 of the imaging sensor 450. Moreover, the controller 500 may use the predicted trajectory TR of the person 20 to track a person 20 headed down a corridor and then, where possible, maneuver along a shorter path using the layout map 700 to arrive at a location along the predicted trajectory TR ahead of the person 20 to be nearly still when the person 20 enters the field of view 452 of the imaging sensor 450.

In some examples, the controller 500 accommodates for limitations of the drive system 200. For example, the drive system 200 may have higher deceleration limits for a stop command than a slow-down command. Moreover, the controller 500 may accommodate for any latency between sending an image capture request to the imaging sensor 450 and the actual image capture by the imaging sensor 450. By knowing the declaration limits of the drive system 200 and an image capture latency of the imaging sensor 450, the controller 500 can coordinate movement commands (e.g., to move and stop) with image capture commands to the imaging sensor 450 to capture clear, recognizable images 50 of a person 20.

In some implementations, the drive system 200 has a normal acceleration/deceleration limit of 13.33 radians/sec for each wheel 210a-d and a stop deceleration limit of 33.33 radians/sec for each wheel 210a-d. Moreover, the imaging sensor 450 may have a horizontal field of view θ_{V-H} of 50 degrees and a vertical field of view θ_{V-V} of 29 degrees. For this scenario, the controller 500 may command the drive system 200 and/or portions of the robot body 110 to move the imaging sensor 450 so that a moving object 12, projected 0.25 seconds in the future (based on a predicted trajectory TR of the object 12 and a speed estimate), is within 21 degrees of the imaging sensor 450 and a current rotational velocity of the robot 100 (as measured by the IMU 470) is less than 15 degrees per second. A linear velocity of the robot 100 may not have as high of an impact on image blur as rotational velocity. When the object 12 is not in frame, the controller 500 may project the object trajectory TR two seconds into the future and command the drive system 200 to move to a location in one second (adjusting at 10 Hz). If the sign of the current rotational velocity of the robot 100 is opposite of a commanded rotational velocity, the controller 500 may issue a stop command (e.g., zero velocity command) first to use the higher acceleration/deceleration limit associated with the stop command, and then start commanding a desired speed when the robot 100 approaches a velocity close to zero. Similarly, if a linear velocity of the robot 100 is >0.2 m/s, the controller 500 may issue the stop command before issuing the rotational command to the drive system 200.

In examples where the imaging sensor 450 provides three-dimensional volumetric point cloud data, the controller 500 may use the three-dimensional volumetric point cloud data to determine a distance of the person 20 from the robot 100 and/or a movement trajectory TR of the person 20 and then adjust a position or movement of the robot 100 with respect to the person 20 (e.g., by commanding the drive system 200) to bring the person 20 within a focal range of the imaging sensor 450 or another imaging sensor 450a-c on the robot 100 and/or to bring the person 20 into focus.

In some examples, the controller 500 accounts for lighting in the scene 10. If the robot 100 is not equipped with a good light source for dark locations in the scene 10 or if the robot 100 is in a highly reflective location of the scene, where a light source may saturate the image 50, the controller 500 may perceive that the images 50 are washed out or too dark and continue tracking the person 20 until the lighting conditions improve and the robot 100 can capture clear recognizable images 50 of the person 20.

The controller 500 may consider the robot dynamics (e.g., via the sensor system 400), person dynamics (e.g., as observed by the sensor system 400 and/or propagated by a behavior 530), and limitations of the imaging sensor(s) 450 (e.g., shutter speed, focal length, etc.) to predict movement of the person 20. By predicting movement of the person 20 and maneuvering based on the predicted movement, the robot 100 may capture clear/recognizable images 50 of the person 20. Moreover, the robot 100 can send a surveillance report 1010 (FIG. 1B) to the security system 1000 (or some other remote recipient) that contains a message 1012 and/or attachments 1014 that are useful for surveillance of the environment 10. The message 1012 may include a date-timestamp, location of the robot 100, information relating to dynamics of the robot 100, and/or information relating to dynamics of the person 20 (e.g., location, heading, trajectory, etc.). The attachments 1014 may include images 50 from the imaging sensor(s) 450, the layout map 700, and/or other information. In some examples, the surveillance report 1010 includes a trajectory prediction TR of the person 20 (or other object) drawn schematically on the map 700. The images 50 may correspond to the observed moving object 12 (e.g., the person 20) and/or the environment 10 about the robot 100. The surveillance report 1010 enables a remote user to make a determination whether there is an alarm condition or a condition requiring no alarm (e.g. a curtain blowing in the wind).

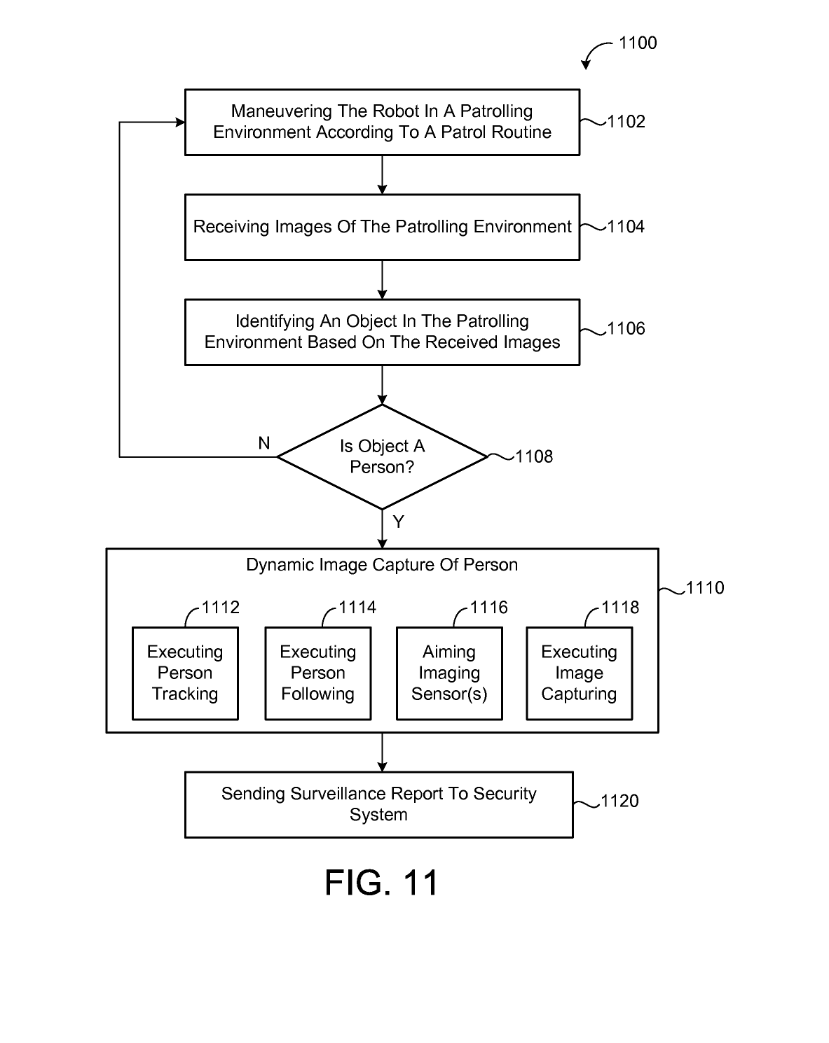

FIG. 11 provides an exemplary arrangement of operations, executable on the controller 500, for a method 1100 of operating the robot 100 when a moving object 12 or a person 20 is detected while maneuvering the robot 100 in a patrol environment 10 using a layout map 700. The layout map 700 can be provided by the security system 1000 or another source. With additional reference to FIGS. 10A and 10B, at operation 1102, the method 1100 includes maneuvering the robot 100 in the patrolling environment 10 according to a patrol routine. The patrol routine may be a scheduled patrol routine including autonomous navigation paths between specific locations or control points on the layout map 700. At operation 1104, the method 1100 includes receiving images 50 of the patrolling environment 10 about the robot 100 (via the imaging sensor(s) 450). At operation 1106, the method 1100 includes identifying an object 12 in the patrolling environment 10 based on the received images 50, and at operation 1108, determining if the object 12 is a person 20. If the object 12 is not a person 20, the method 1100 may resume with maneuvering the robot 100 in the patrolling environment 10 according to a patrol routine, at operation 1102. If the object 12 is a person 20, the method 1100 includes executing a dynamic image capture routine 1110 to capture clear images 50 of the person 20, which may be moving with respect to the robot 100. The dynamic image capture routine 1110 may include executing one or more of person tracking 1112, person following 1114, aiming 1116 of image sensor(s) 450 or image capturing 1118, so that the robot 100 can track the person, control its velocity, aim its imaging sensor(s) and capture clear images 50 of the person 20, while the person 20 and/or the robot 100 are moving with respect to each other.

The controller 500 may execute person tracking 1112, for example, by employing the multi-target tracker 820 (FIG. 8C) to track a trajectory TR of the person 20 (e.g., by using a Kalman filter). In some implementations, the controller 500 commands the robot 100 (e.g., by issuing drive commands to the drive system 200) to move in a planar direction with three planar degrees of freedom while maintaining the aimed field of view 452, 652 of the at least one imaging sensor 450, 650 on the identified person 20 associated with the movement trajectory TR. In some examples, the drive system 200 moves the robot 100 in the planar direction at a velocity proportional to the movement trajectory (e.g., person velocity 822). In some implementations, the controller 500 commands the robot 100 (e.g., aiming component 840) to aim the at least one imaging sensor 450, 650 to maintain the aimed field of view 452, 652 on the identified person 20 associated with the movement trajectory TR (e.g., via the rotator 152 and/or the tilter 154, or the sensor module 300). In some examples, the aiming component 840 moves the imaging sensor 450, 650 at a velocity proportional to the movement trajectory TR of the identified person 20. Additionally, the velocity of aiming movement may be further proportional to a planar velocity of the robot 100 and may take into consideration limitations including focal range and shutter speed of the imaging sensor 450.

The controller 500 may execute the person following 1114 (e.g., employing the drive component 830 and/or the aiming component 840 (FIG. 8D)) to maintain a following distance D_{R} on the person 20. The controller 500 may execute the aiming 1116 of imaging sensor(s) 450 (e.g., employing the aiming component 840 (FIG. 8E)) to determine an appropriate pan angle 842 and/or tilt angle 844 that may translate the imaging sensor(s) 450, 650 to maintain its field of view 452, 652 to continuously perceive the person 20. The controller 500 executes image capturing 1118 to capture a clear, human recognizable still image and/or video of the person 20, while considering limitations of the imaging sensor 450, such as shutter speed and focal range, for example. When the controller 500 commands the at least one imaging sensor 450, 650 to capture a human recognizable image (or video), the controller 500 may execute one or more components of the person following behavior 530b to maintain the aimed field of view 452, 652 of the imaging sensor 450, 650 on the identified person 20. For example, the controller 500 may command the robot to move holonomically and/or command the aiming component 840 to maintain the aimed field of view 452, 652 to continuously perceive the person 20 in the field of view 452, 652 of the one or more imaging sensors 450, 650 (e.g., of the sensor module 300, the interface module 140, or elsewhere on the robot 100).

The method 1100 may include, at operation 1120, sending a surveillance report 1010 to the security system 1000 or some other remote recipient. As discussed above, the surveillance repot 1010 may include information regarding the dynamic state of the robot 100 (e.g., location, heading, trajectory, etc.), the dynamic state of the observed object 12 or person 20 (e.g., location, heading, trajectory, etc.), and/or images 50 captured of the observed object 12 or person 20.

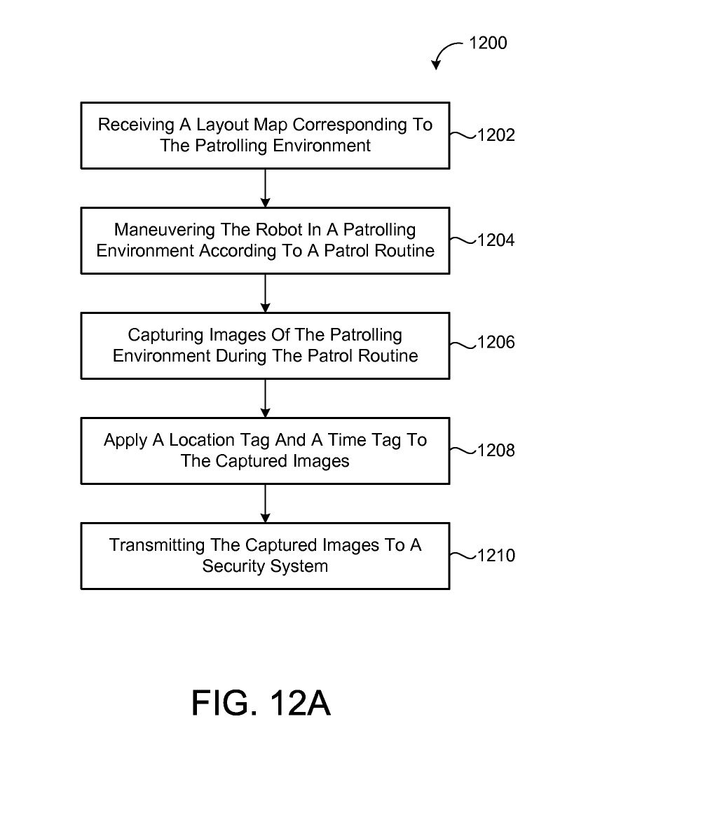

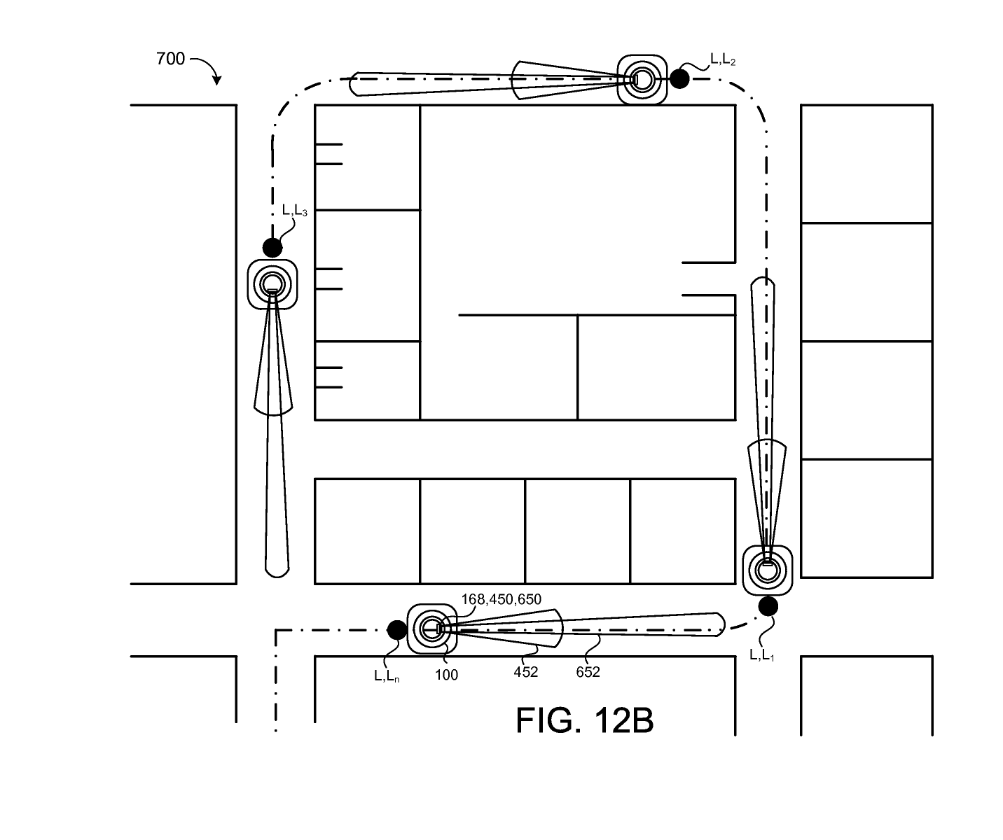

FIG. 12A provides an exemplary arrangement of operations, executable on the controller 500, for a method 1200 of operating the robot 100 to patrol an environment 10 using a layout map 700. FIG. 12B illustrates an example layout map 700 of an example patrol environment 10. The method 1200 includes, at operation 1202, receiving the layout map 700 (e.g., at the controller 500 of the robot 100 from a security system 1000 or a remote source) corresponding to the patrolling environment 10 for autonomous navigation during a patrolling routine. For example, the patrolling routine may provide specific locations L, L₁₋ₙ (FIG. 12B) or control points on the layout map 700 for autonomous navigation by the robot 100. The security system 1000 may provide the layout map 700 to the robot 100 or the robot 100 may learn the layout map 700 using the sensor system 400. The patrolling routine may further assign predetermined time intervals for patrolling the specific locations L on the layout map 700. At operation 1204, the method 1200 includes maneuvering the robot 100 in the patrolling environment 10 according to the patrol routine, and at operation 1206, capturing images 50 of the patrolling environment 10 during the patrol routine using the at least one imaging sensor 450, 650. In the example shown, the controller 500 schedules the patrolling routine for the robot 100 to capture human recognizable images 50 (still images or video) in the environment 10 using the at least one imaging sensor 450, 650, while maneuvering in the patrolling environment 10. For example, while on patrol, the robot 100 senses a moving object 12, determines the object 12 is a person 20, and tracks the moving person 20 to get an image 50 and calculate a trajectory TR of the person 20. To successfully capture an image 50 and calculate a trajectory TR, the controller 500 takes in to account the velocity of the robot 100, the robot mass and center of gravity CG_{R} for calculating deceleration, and a particular shutter speed and focal range of the imaging sensor 450 so that the imaging sensor 450 is properly positioned relative to the moving person 20 to capture a discernable still image and/or video clip for transmission to a remote user, such as the security system 1000.

In some examples, the robot 100 captures human recognizable still images 50 of the environment 10 during repeating time cycles. Likewise, the robot 100 may continuously capture a video stream while maneuvering about the patrolling environment 10. In some examples, the controller 500 schedules the patrolling routine for the robot 100 to capture human recognizable still images 50 at desired locations L, L₁₋ₙ on the layout map 700. For example, it may be desirable to obtain images 50 in high security areas of the patrolling environment 10 versus areas of less importance. The capture locations L may be defined by a location on the layout map 700 or may be defined by a location based on at least one of robot odometry, waypoint navigation, dead-reckoning, or a global positioning system. In some implementations, the robot 100 aims the field of view 452, 652 of the imaging sensors 450, 650 upon desired areas of the patrolling environment 10 through scanning to capture human recognizable still images and/or video of the desired areas, or to simply increase the field of view 452, 652 coverage about the environment 10. For example, the robot 100 may maneuver about travel corridors in the patrolling environment 10 and scan the imaging sensor 450, 650 side-to-side with respect to a forward drive direction F of the robot 100 to increase a lateral field of view V-H of the imaging sensor 450, 650 to obtain images and/or video 50 of rooms adjacent to the travel corridors. Moreover, the field of view 452, 652 of the imaging sensor 450, 650 may be aimed in a direction substantially normal to a forward drive direction F of the robot 100 or may be scanned to increase the corresponding field of view 452, 652 (and/or perceive desired locations in the patrolling environment 10).

The method 1200 may include, at operation 1208, applying a location tag and a time tag to the captured image 50. The location may define a location L on the layout map 700 or the location may be defined based on at least one of robot odometry, waypoint navigation, dead-reckoning, or a global positioning system. In some examples, the robot 100 (via the controller 500) tags each image 50 (still image 50 and/or video) captured with the corresponding location and time. The robot 100 (via the controller 500) may store the captured images 50 within the non-transitory memory 504 (FIG. 2A). At operation 1210, the method 1200 includes transmitting the images 50 and/or video and associated location/time tags in a surveillance report 1010 (e.g., FIG. 1B) to the security system 1000 upon commencing or completing the patrolling routine or instantaneously after capturing each image 50 and/or video. For example, the robot 100 may communicate with the security system 1000 by transmitting emails, a text message, a short message service (SMS) message, or an automated voice mail including the captured images (or video) 50. Other types of messages are possible as well, which may or may not be sent using the network 102.

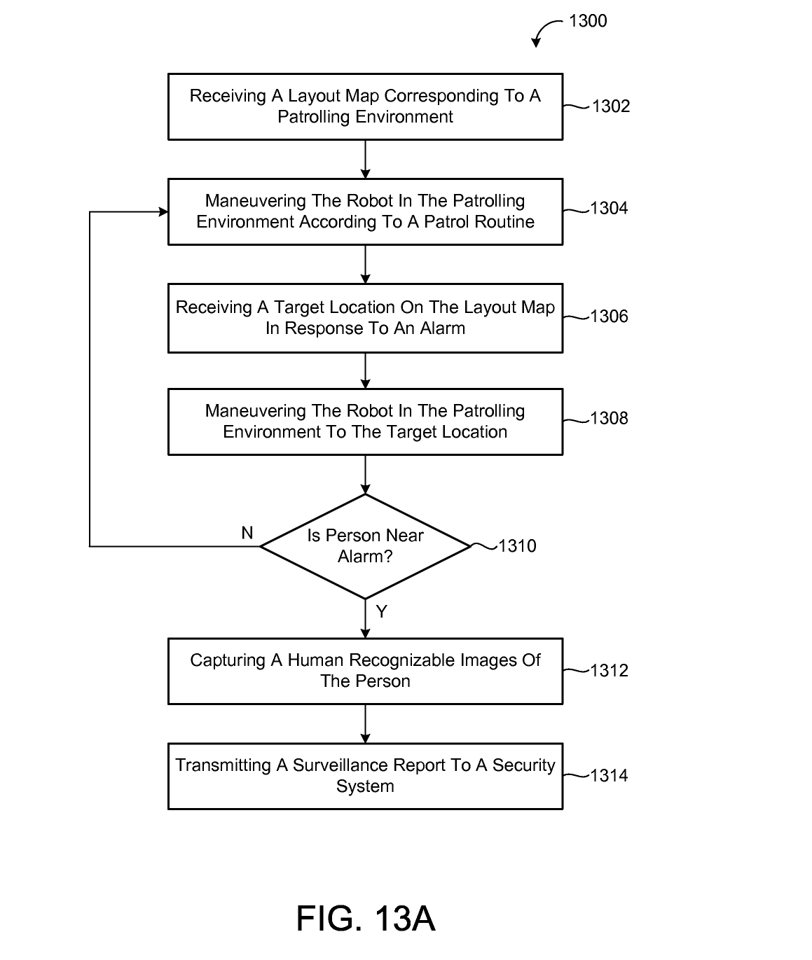

FIG. 13A provides an exemplary arrangement of operations, executable on the controller 500, for a method 1300 of operating a mobile robot 100 when an alarm A is triggered while the robot 100 navigates about a patrolling environment 10 using a layout map 700. FIG. 13B illustrates an example layout map 700 indicating a location of the alarm A, the robot 100, and a person 20. At operation 1302, the method 1300 includes receiving the layout map 700 of the patrolling environment 10 (e.g., from the security system 1000 or another source), and at operation 1304, maneuvering the robot 100 in the patrolling environment 10 according to a patrol routine (e.g., as discussed above, by moving to locations L on the layout map 700). At operation 1306, the method 1300 includes receiving a target location L₂ on the layout map 700 (e.g., from the security system 1000), in response to an alarm A. The method 1300 includes, at operation 1308, maneuvering the robot 100 to the target location L₂ to investigate the alarm A.

In the example shown, the robot 100 receives a signal indicating a triggered alarm A at an area in the patrolling environment 10. The alarm A may include a proximity sensor, motion sensor, or other suitable sensor detecting presence of an object 12 and communicating with the security system 1000. In the example shown, the robot 100 is driving in a forward drive direction F when the alarm A is triggered. The security system 1000 may receive an alarm signal S from the triggered alarm A and notify the robot 100 of the alarm A and provide a target location L, L₂ associated with a location of the alarm A. In some examples, the target location L defines a location on the layout map 700. Additionally or alternatively, the target location L defines a location based on at least one of odometry, waypoint navigation, dead-reckoning, or a global positioning system. In some examples, the controller 500 issues one or more waypoints and/or drive commands to the drive system 200 to navigate the robot 100 to the target location L associated with the location L₂ of the alarm A. In the example shown, the one or more drive commands cause the robot 100 to turn 180 degrees from its current forward drive direction F and then navigate to the target location L, L₂ associated with the alarm A.

The method 1300 may include, at operation 1310, determining if a person 20 is near the alarm location L₂. If a person 20 is not near the alarm, the method 1300 may include resuming with patrolling the environment 10 according the patrol routine. As discussed above, the controller 500 may determine the presence of a person 20 by noticing a moving object 12 and assuming the moving object 12 is a person 20, by noticing an object 12 that meets a particular height range, or via pattern or image recognition. Other methods of people recognition are possible as well. If a person 20 is determined present, the method 1300 may include, at operation 1312, capturing a human recognizable image 50 (still images 50 and/or video) of the person 20 using the image sensor(s) 450, 650 of the robot 100.

The robot 100 may use the imaging sensors 450 to detect objects 12 within the field of view 452, 652 proximate the alarm A and detect if the object 12 is a person 20. The robot 100, via the controller 500, using at least one imaging sensor 450, 650, may capture a human recognizable image 50 and/or video of the person 20 by considering the dynamic movement of the person 20 relative to the robot 100 and the limitations of the imaging sensor 450, 650 (as discussed above), so that the captured image 50 is clear enough for a remote user (e.g., in communication with the security system 1000 and/or the robot 100) to identify an alarm situation or a non-alarm situation and so that the image 50 is useful for identifying the person(s) 20 moving in the patrolling environment 10. As discussed above with reference to FIG. 11, the controller 500 may execute one or more of person tracking 1112, person following 1114, and imaging capturing 1116 to move the robot 100 and/or the imaging sensor(s) 450, 650 relative to the person 20, so that the robot 100 can capture clear images 50 of the person 20, especially when the person 20 may be moving (e.g., running away from the location of the robot 100). In some examples, the controller 500 commands the robot 100 to track and/or follow the identified person 20 to further monitor activities of the person 20.

The method 1300 may include, at operation 1314, transmitting a surveillance report 1010 to the security system and/or a remote user or entity. As previously discussed, the robot 100 may tag the image(s) 50 with a corresponding location and a time associated with the captured image 50 and/or video and transmit the tagged image 50 to the security system 1000 in a surveillance report 1010 (FIG. 1B). Moreover, the robot 100 may store the tagged image 50 in the non-transitory memory 504.

Referring to FIGS. 14A-14D, in some implementations, the controller 500 executes the aiming behavior 530e to effectuate two goals: 1) aiming the field of view 452, 652 of the imaging sensor 450, 650 to continuously perceive the person 20, as shown in FIG. 14A, and maintaining the aimed field of view 452, 652 on the person 20 (e.g., moving the robot 100 holonomically with respect to the person 20 and/or aiming the imaging sensor 450, 650 with respect to the person 20) so that that the center of the field of view 452, 652 continuously perceives the person 20, as shown in FIGS. 14B and 14C. For instance, FIG. 14B shows the controller 500 issuing drive commands to the drive system 200, causing the robot 100 to move in the planar direction with respect to the movement trajectory TR associated with the person 20. Likewise, FIG. 14C shows the controller 500 commanding the at least one imaging sensor 450, 650 to move with respect to the movement trajectory TR (e.g., at least one of rotate, pan, or tilt) and planar velocity of the robot 100. After the robot 100 captures a human recognizable image 50 and/or video of the person 20, the controller 500 may issue drive commands to the drive system 200, causing the robot 100 to turn and drive away from the person 20 or continue tracking and following the person 20, as described above.

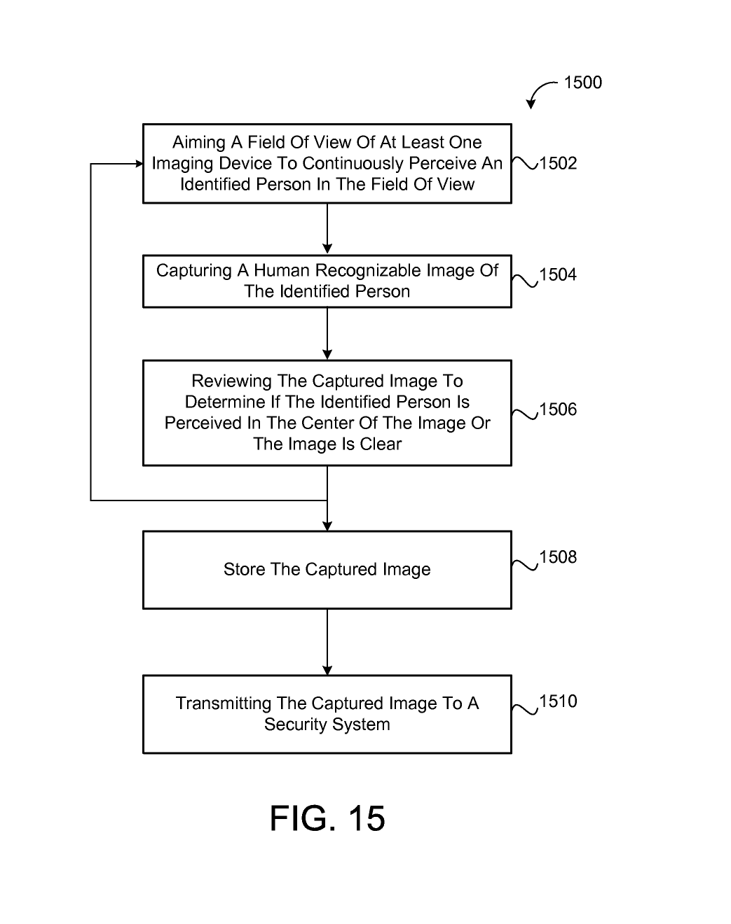

FIG. 15 provides an exemplary arrangement of operations for a method 1500 of capturing one or more images 50 (or video) of a person 20 identified in a patrolling environment 10 of the robot 100. The method 1500 may be executed by the controller 500 (e.g., computing device). The controller 500 may be the robot controller or a controller external to the robot 100 that communicates therewith. At operation 1502, the method 1500 includes aiming the field of view 452, 652 of at least one imaging sensor 450, 650 to continuously perceive an identified person 20 in the corresponding field of view 452, 652. At operation 1504, the method 1500 includes capturing a human recognizable image 50 (or video) of the person 20 using the imaging sensor(s) 450, 650. For example, for operation 1502 and/or 1504, the controller 500 may execute the dynamic image capture routine 1110 (FIG. 11) to capture clear images 50 of the person 20, which may be moving with respect to the robot 100. The dynamic image capture routine 1110 may include executing one or more of person tracking 1112, person following 1114, aiming 1116 of image sensor(s) 450 or image capturing 1118, so that the robot 100 can track the person, control its velocity, aim its imaging sensor(s) and capture clear images 50 of the person 20, while the person 20 and/or the robot 100 are moving with respect to each other. The controller 500 may accommodate for limitations of the imaging sensor 450 by maneuvering the robot 100 based on a trajectory TR of the person 20 to capture image data 50 (e.g., still images or video) of the person 20 along a field of view 452 of the imaging sensor 450. The controller 500 may account for dynamics of the person 20 (e.g., location, heading, trajectory, velocity, etc.), shutter speed of the imaging sensor 450 and dynamics of the robot 100 (e.g., velocity/holonomic motion) to aim the corresponding field of view 452 of the imaging sensor 450 to continuously perceive the person 20 within the field of view 452, so that the person 20 is centered in the captured image 50 and the image 50 is clear. Moreover, the controller 500 may execute movement commands to maneuver the robot 100 in relation to the location of the person 20 to capture a crisp image 50 of a facial region of the person 20, so that the person 20 is recognizable in the image 50. In some examples, the controller 500 associates a location tag and/or a time tag with the image 50. At operation 1506, the controller 500 reviews the captured image 50 to determine if the identified person 20 is perceived in the center of the captured image 50 or if the captured image 50 is clear. When the identified person 20 is perceived in the center of the image 50 and the image 50 is clear, the method 1500 includes, at operation 1508 storing the captured image 50 in non-transitory memory 504 (FIG. 2A) in communication with the controller 500 and, at operation 1510, transmitting the captured image 50, e.g., in a surveillance report 1010, to the security system 1000 or another remote recipient in communication with the controller 500. In some examples, the controller 500 retrieves one or more captured images 50 from the non-transitory memory 504 and transmits the one or more captured images 50 to security system 1000. In other examples, at operation 1508, the controller 500 simultaneously stores a captured image 50 and transmits the captured image 50 to the security system 1000 upon capturing the image 50. However, when the identified person 20 is perceived outside the center of the image 50 or the image 50 is blurred, the method 1500 includes repeating operations 1502-1506 to re-aim the field of view 452, 652 of the at least one imaging sensor 450, 650 to continuously perceive the identified person 20 in the field of view 452, 652, capture a subsequent human recognizable image 50 of the identified person 20 using the at least one imaging sensor 450, 650 and review the captured image 50 to see if the person 20 is at least in or centered in the image 50. The security system 1000 and/or remote recipient of the surveillance report 1010 may review the image(s) 50 in lieu of the robot 100 or in addition to the robot 100 to further assess a nature of the image(s) 50 (e.g., whether the image(s) 50 raises a security concern). In some examples, the controller 500 and/or the security system 1000 executes one or more image enhancement routines to make the image(s) 50 more clear, to crop the image(s) 50 around objects of interest, or other image manipulations.

While operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method of operating a mobile robot, the method comprising:
receiving, at a computing device, a layout map corresponding to a patrolling environment;
maneuvering the robot in the patrolling environment based on the received layout map;
receiving, at the computing device, imaging data of a scene about the robot when the robot maneuvers in the patrolling environment, the imaging data received from at least one imaging sensor disposed on the robot and in communication with the computing device;
identifying, by the computing device, a person in the scene based on the received imaging data;
aiming, by the computing device, a field of view of the at least one imaging sensor to continuously perceive the identified person in the field of view based on robot dynamics, person dynamics comprising a movement trajectory of the person, and imaging sensor dynamics of the at least one imaging sensor; and
capturing, by the computing device, a human recognizable image of the identified person using the at least one imaging sensor.

2. The method of claim 1, further comprising:
segmenting, by the computing device, the received imaging data into objects;
filtering, by the computing device, the objects to remove objects greater than a first threshold size comprising a first height of about 8 feet and smaller than a second threshold size comprising a second height of about 3 feet; and
identifying, by the computing device, the person in the scene corresponding to at least a portion of the filtered objects.

3. The method of claim 1, further comprising at least one of:
aiming, by the computing device, the at least one imaging sensor to maintain the corresponding aimed field of view on a facial region of the identified person; or
commanding, by the computing device, holonomic motion of the robot to maintain the aimed field of view of the at least one imaging sensor on the facial region of the identified person.

4. The method of claim 1, further comprising using, by the computing device, a Kalman filter to track and propagate the movement trajectory of the identified person.

5. The method of claim 4, further comprising commanding, by the computing device, the robot to move in a planar direction with three planar degrees of freedom while maintaining the aimed field of view of the at least one imaging sensor on the identified person associated with the movement trajectory.

6. The method of claim 5, wherein the robot moves in the planar direction at a velocity proportional to the movement trajectory of the identified person.

7. The method of claim 4, further comprising commanding, by the computing device, at least one of panning or tilting the at least one imaging sensor to maintain the aimed field of view of the at least one imaging sensor on the identified person associated with the movement trajectory.

8. The method of claim 1, further comprising:
reviewing, by the computing device, the captured image to determine whether or not the identified person is perceived in a center of the image or the image is clear;
when the identified person is perceived in the center of the image and the image is clear:
storing the captured image in non-transitory memory in communication with the computing device; and
transmitting, by the computing device, the captured image to a security system in communication with the computing device; and
when the identified person is perceived outside the center of the image or the image is blurred:
re-aiming the field of view of the at least one imaging sensor to continuously perceive the identified person in the field of view; and
capturing a subsequent human recognizable image of the identified person using the at least one imaging sensor,
wherein the imaging sensor dynamics comprise a threshold rotational velocity of the imaging sensor relative to an imaging target to capture a clear image of the imaging target.

9. The method of claim 1, further comprising:
applying, by the computing device, a location tag to the captured image associated with a location of the identified person;
applying, by the computing device, a time tag associated with a time the image was captured; and
transmitting a tagged layout map from the computing device to a remote device.

10. The method of claim 9, wherein the location tag defines a location on the layout map.

11. The method of claim 1, wherein the at least one imaging sensor comprises at least one of a still-image camera, a video camera, a stereo camera, or a three-dimensional point cloud imaging sensor.

12. The method of claim 1, wherein the robot dynamics comprise:
a first acceleration/deceleration limit of a drive system of the robot;
a second acceleration/deceleration limit associated with a drive command; and
a deceleration limit associated with a stop command.

13. A robot comprising:
a robot body;
a drive system supporting the robot body and configured to maneuver the robot over a floor surface of a patrolling environment, the drive system having a forward drive direction;
at least one imaging sensor disposed on the robot body; and
a controller in communication with the drive system and the at least one imaging sensor, the controller:
receiving a layout map corresponding to a patrolling environment;
issuing drive commands to the drive system to maneuver the robot in the patrolling environment based on the received layout map;
receiving imaging data from the at least one imaging sensor of a scene about the robot when the robot maneuvers in the patrolling environment;
identifying a moving target in the scene based on the received imaging data;
propagating a movement trajectory of the identified moving target based on the received imaging data;
aiming a field of view of the at least one imaging sensor to continuously perceive the identified moving target in the field of view; and
capturing a human recognizable image of the identified moving target using the at least one imaging sensor.

14. The robot of claim 13, wherein the controller:
segments the received imaging data into objects;
filters the objects to remove objects greater than a first threshold size comprising a first height of about 8 feet and smaller than a second threshold size comprising a second height of about 3 feet; and
identifies a person in the scene as the identified moving target corresponding to at least a portion of the filtered objects.

15. The robot of claim 14, further comprising a rotator and a tilter disposed on the robot body in communication with the controller, the rotator and tilter providing at least one of panning and tilting of the at least one imaging sensor, wherein the controller at least one of:
commands the rotator or tilter to at least one of pan or tilt the at least one imaging sensor to maintain the corresponding aimed field of view on a facial region of the identified person; or
issues drive commands to the drive system to holonomically move the robot to maintain the aimed field of view of the at least one imaging sensor on the facial region of the identified person.

16. The robot of claim 15, wherein the controller commands the drive system to drive in a planar direction with three planar degrees of freedom at a velocity proportional to the movement trajectory of the identified moving target while maintaining the aimed field of view of the at least one imaging sensor on the identified moving target associated with the movement trajectory.

17. The robot of claim 13, further comprising a rotator and a tilter disposed on the robot body and in communication with the controller, the rotator and tilter providing at least one of panning and tilting of the at least one imaging sensor, wherein the controller commands the rotator or the tilter to at least one of pan or tilt the at least one imaging sensor to maintain the aimed field of view of the at least one imaging sensor on the identified moving target associated with the movement trajectory, wherein the least one of the commanded panning or tilting is at a velocity proportional to the movement trajectory of the identified moving target and proportional to a planar velocity of the robot.

18. The robot of claim 13, wherein the controller reviews the captured image to determine whether the identified moving target is perceived in a center of the image or the image is clear;
when the identified moving target is perceived in the center of the image and the image is clear, the controller:
stores the captured image in non-transitory memory in communication with the controller; and
transmits the captured image to a security system in communication with the controller; and
when the identified moving target is perceived outside the center of the image or the image is blurred, the controller:
re-aims the field of view of the at least one imaging sensor continuously perceive the identified moving target in the field of view; and
captures a subsequent human recognizable image of the identified moving target using the at least one imaging sensor.

19. The robot of claim 13, wherein the controller:
applies a location tag to the captured image associated with a location of the identified moving target, the location tag defining a location on the layout map based on at least one of robot odometry, waypoint navigation, dead-reckoning, or a global positioning system; and
applies a time tag associated with a time the image was captured.

20. The robot of claim 13, wherein the at least one imaging sensor comprises at least one of a still-image camera, a video camera, a stereo camera, or a three-dimensional point cloud imaging sensor.

21. The robot of claim 13, wherein the controller aims the at least one imaging sensor based on acceleration/deceleration limits of the drive system and a latency between sending an image capture request to the at least one imaging sensor and the at least one imaging sensor capturing an image, wherein the acceleration/deceleration limits of the drive system comprise an acceleration/deceleration limit associated with a drive command and a deceleration limit associated with a stop command.

22. The robot of claim 21, wherein the controller determines a movement trajectory of the identified moving target and aims the at least one imaging sensor based on the movement trajectory of the identified moving target.
